(19) United States
(12) Patent Application Publication
(10) Pub. No.: US 2025/0084198 A1
(43) Pub. Date: Mar. 13, 2025

(54) COMPOSITE ADHESIVES

(71) Applicant: 3M INNOVATIVE PROPERTIES COMPANY, St. Paul, MN (US)

(72) Inventors: Michael J. Maher, St. Paul, MN (US); Adam O. Moughton, Minneapolis, MN (US); Maria O. Miranda, Minneapolis, MN (US); Deborah K. Schneiderman, St. Paul, MN (US); Aaron T. Hedegaard, Woodbury, MN (US); Jilliann M. Nelson, Maplewood, MN (US)

(21) Appl. No.: 18/723,907

(22) PCT Filed: Mar. 1, 2023
(86) PCT No.: PCT/IB2023/051903

§ 371 Date: Jun. 25, 2024

Related U.S. Application Data
(60) Provisional application No. 63/319,937, filed on Mar. 15, 2022.
(60) Provisional application No. 63/423,225, filed on Nov. 7, 2022.

(51) Int. Cl. C08F 220/28; C08K 5/09; C09J 133/14

(52) U.S. Cl. CPC C08F 220/286; C08K 5/09; C09J 133/14

(57) ABSTRACT

Described herein is an adhesive composite composition. The composition comprises: a plurality of polymeric microspheres dispersed within a (meth)acrylate-based matrix, wherein the polymeric microspheres are derived from 20 to 99 wt % of a (meth)acrylate monomer having a Tg above room temperature and at least 1 wt % of a polar (meth)acrylate monomer; and the (meth)acrylate-based matrix is derived from a C1 to C20 (meth)acrylate ester monomer and at least 1 wt % of a (meth)acrylate macromer. In some embodiments, these composite adhesives show good impact resistance and good shear. In one embodiment, an ionic liquid is added to the adhesive composite composition to aid in electro-debonding of articles.

This disclosure relates to an impact resistant adhesive comprising a (meth)acrylate-based matrix with a plurality of polymeric microspheres dispersed therein.

### SUMMARY

In electronic devices, particularly mobile electronic devices (e.g., handheld or wearable electronic devices), pressure sensitive adhesives (PSAs) are typically used to bond the cover glass (or lens) to the underlying display module, bond the touch sensor to the cover glass and the display, or bond the lower components of the display to the housing. The pressure-sensitive adhesives used in mobile electronic devices are usually optically clear adhesives (OCAs). For these applications (commonly referred to as electronics bonding, or e-bonding), PSAs and OCAs should have an adhesive strength that is sufficiently strong to properly maintain good adhesion to those components, not only when the mobile electronic devices are operating under normal conditions, but also when they are deformed by external forces (e.g., bending, folding, flexing), subjected to traumatic forces (e.g., dropping of the mobile electronic device onto a hard surface), or subjected to extreme environmental conditions (e.g. high temperatures and/or high humidity conditions). Regarding deformation, the components of the electronic devices may be deformed when a user sits in a chair while the electronic device is in their pocket or presses down on the electronic device with their hips. Under such conditions, the pressure sensitive adhesives should have strength of adhesion sufficient to maintain the adhesion to, for example, the cover glass (sometimes referred to as anti-lifting properties). Regarding traumatic forces, the pressure sensitive adhesives should have sufficient drop/impact resistance such that the pressure sensitive adhesive maintains adhesion of the components even when large instantaneous impacts are applied to the mobile electronic device when dropped.

Given the electronics industry's trend towards device simplification (i.e., combining layers and/or layer functions) and reducing bonding area and overall device thickness, (and moreover demanding enhanced flexibility), there exists a growing need for adhesive tapes that have good impact resistance, compliance, and recovery. Adhesives having this balance of dichotomous properties are needed.

In one aspect, a composition is disclosed. The composition comprises: (i) a plurality of polymeric microspheres, wherein the polymeric microspheres are derived from 20 to 99 wt % of a (meth)acrylate monomer having a glass transition temperature (Tg) above room temperature and at least 1 wt % of a polar (meth)acrylate monomer; and (ii) a polymerizable matrix comprising: (a) a (meth)acrylate macromer, wherein the (meth)acrylate macromer comprises a poly(ethylene oxide) group, a poly(propylene oxide) group, a poly(ethylene oxide-co-propylene oxide), a poly(tetrahydrofuran) group, or combinations thereof; (b) one or more of a C₁ to C₂₀ (meth)acrylate ester monomer; and (c) a cross-linking agent.

In another aspect, a composition is disclosed. The composition comprises: (i) a plurality of polymeric microspheres, wherein the polymeric microspheres are derived from 20 to 99 wt % of a (meth)acrylate monomer having a Tg above room temperature and at least 1 wt % of a polar (meth)acrylate monomer; and (ii) a matrix derived from (a) a (meth)acrylate macromer, wherein the (meth)acrylate macromer comprises a poly(ethylene oxide) group, a poly(propylene oxide) group, a poly(ethylene oxide-co-propylene oxide), a poly(tetrahydrofuran) group, or combinations thereof; (b) one or more of a C₁ to C₂₀ (meth)acrylate ester monomer; and (c) a cross-linking agent.

In another aspect, an adhesive article is described. The adhesive article comprising the adhesive composition derived from one of the compositions described above, wherein the pressure sensitive adhesive composition is disposed on a substrate.

In yet another embodiment, at least 0.7 wt % and less than 10 wt % of an ionic liquid is added to the composition to assist in the electro-debonding of adherend substrates.

In yet another embodiment, a method of making an adhesive article is described. The method comprising:
(i) obtaining a polymerizable matrix comprising:
(a) a (meth)acrylate macromer, wherein the (meth)acrylate macromer comprises a poly(ethylene oxide) group, a poly(propylene oxide) group, a poly(ethylene oxide-co-propylene oxide), a poly(tetrahydrofuran) group, or combinations thereof;
(b) one or more of a C₁ to C₂₀ (meth)acrylate ester monomer; and
(c) a cross-linking agent; and
(ii) adding a plurality of polymeric microspheres to the polymerizable matrix to form a composition, wherein the polymeric microspheres are derived from 20 to 99 wt % of (meth)acrylate monomer having a Tg above room temperature and at least 1 wt % of a polar (meth)acrylate monomer.

In still another embodiment, a method of making an adhesive article is described. The method comprising:
(i) obtaining a polymerizable matrix comprising:
(a) at least 1 wt % of a (meth)acrylate macromer, wherein the (meth)acrylate macromer comprises a poly(ethylene oxide) group, a poly(propylene oxide) group, a poly(ethylene oxide-co-propylene oxide), a poly(tetrahydrofuran) group, or combinations thereof;
(b) one or more of a C₁ to C₂₀ (meth)acrylate ester monomer; and
(c) a cross-linking agent;
(ii) at least partially polymerizing the polymerizable matrix to form an at least partially polymerized composition, and
(iii) adding a plurality of polymeric microspheres to the at least partially polymerized composition to form a composition, wherein the polymeric microspheres are derived from 20 to 99 wt % of (meth)acrylate monomer having a Tg above room temperature and at least 1 wt % of a polar (meth)acrylate monomer.

The above summary is not intended to describe each embodiment. The details of one or more embodiments of the invention are also set forth in the description below. Other features, objects, and advantages will be apparent from the description and from the claims.

### DESCRIPTION OF THE FIGURES

Embodiments of the present disclosure are illustrated by way of example, in the accompanying drawings, which are for illustrative purposes only and not drawn to scale.

FIG. 1 is a schematic cross-sectional view of a multi-layered adhesive article comprising a composite adhesive layer according to one embodiment of the present disclosure; and

FIG. 2 is a schematic cross-sectional view of a composite adhesive layer according to one embodiment of the present disclosure.

FIG. 3A is a top view and FIG. 3B is a side view schematic of the test specimen for the random free fall test.

FIG. 4 is a schematic cross-sectional view of a multi-layered adhesive article comprising a composite adhesive layer according to one embodiment of the present disclosure.

FIG. 5 is a schematic cross-sectional view of a multi-layered adhesive article comprising a composite adhesive layer according to one embodiment of the present disclosure.

### DETAILED DESCRIPTION

As used herein, the term
“a”, “an”, and “the” are used interchangeably and mean one or more; and
“and/or” is used to indicate one or both stated cases may occur, for example A and/or B includes, (A and B) and (A or B);
“cross-linking” refers to connecting two pre-formed polymer chains using chemical bonds or chemical groups in order to increase the modulus of the material; and
“(meth)acrylate” refers to compounds containing either an acrylate (CH₂=CHCOOR) or a methacrylate (CH₂=CCH₃COOR) structure or combinations thereof.

Herein, the term “glass transition temperature”, which can be written interchangeably as “T_{g}”, of a monomer refers to the glass transition temperature of the homopolymer formed from the monomer, which can be a macromer. The glass transition temperature for a polymeric material is typically measured by Dynamic Mechanical Analysis (DMA) as the maximum in tan delta (δ).

As used herein, the term “macromer” refers to a monomer having a polymeric group. A macromer is a subset of the term “monomer”.

The term “monomeric unit” refers to the reaction product of a polymerizable component (i.e., a monomer (including a macromer)) within the (meth)acrylate copolymer. As an example, the monomeric unit of acrylic acid

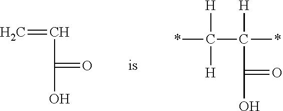

where the asterisks (*) indicate the attachment site to another group such as another monomeric unit or terminal group in the (meth)acrylate copolymer.

The term “(meth)acrylate macromer” refers to a monomer having a single (meth)acryloyloxy group (i.e., a group of formula CH₂=CR—(CO)—O— where R is hydrogen or methyl) plus a poly(ethylene oxide) group, poly(propylene oxide) group, poly(ethylene oxide-co-propylene oxide) group, or poly(tetrahydrofuran) group.

The term “poly(ethylene oxide) group” refers to a group that contains at least 3 ethylene oxide (—(C₂H₄O)—) groups and the term “poly(propylene oxide) group” refers to a group that contains at least 3 propylene oxide (—(C₃H₆O)—) groups.

The term “poly(ethylene oxide-co-propylene oxide) group” contains at least 3 groups that include at least one ethylene oxide group and at least one propylene oxide group. The poly(ethylene oxide-co-propylene oxide) group is a copolymeric group.

The term “poly(tetrahydrofuran) (meth)acrylate macromer” refers to a monomer having a single (meth)acryloyloxy group (i.e., a group of formula CH₂=CR—(CO)—O— where R is hydrogen or methyl) plus a poly(tetrahydrofuran) group that contains at least three —(C₄H₈O)— groups. The term “poly(tetrahydrofuran)” can be used interchangeably with the terms “poly(tetramethylene oxide)” and “poly(tetramethylene glycol)”.

Also herein, recitation of ranges by endpoints includes all numbers subsumed within that range (e.g., 1 to 10 includes 1, 2, 3, 4, 5, 6, 7, 8, 9, and 10).

Also herein, recitation of “at least” followed by a number include the recited number and all numbers greater (for example, “at least one” includes at least 2, at least 4, at least 6, at least 8, at least 10, at least 25, at least 50, at least 100, etc.).

The pressure sensitive adhesives of the present disclosure are a composite comprising a plurality of polymeric microspheres dispersed in a (meth)acrylate-based matrix.

### Polymeric Microspheres

The polymeric microspheres of the present disclosure are derived from a first (meth)acrylate monomer and a polar (meth)acrylate monomer.

The first (meth)acrylate monomer is selected from those (meth)acrylate monomers, wherein a homopolymer of the first (meth)acrylate monomer has a glass transition temperature (Tg) above room temperature (e.g., 23° C.), 50, 80, 100, or even 150° C. In one embodiment, the first (meth)acrylate monomer has a Tg no greater than 200, or even 250° C. Such first (meth)acrylate monomers include alkyl(meth)acrylates comprising at least 1, 2, 4, 6, 8, 10, 12, or even 14 carbon atoms; and at most 16, 18, 20, 25, or even 30 carbon atoms. Examples of such first (meth)acrylate monomers include: methyl methacrylate, ethyl methacrylate, n-propyl methacrylate, isopropyl methacrylate, n-butyl methacrylate, isobutyl methacrylate, sec-butyl methacrylate, tert-butyl (meth)acrylate, cyclohexyl methacrylate, isobornyl (meth)acrylate, stearyl (meth)acrylate, phenyl (meth)acrylate, benzyl methacrylate, 2-phenoxyethyl methacrylate, and 3,3,5 trimethylcyclohexyl (meth)acrylate. In one embodiment, the polymeric microspheres are derived from at least 20, 25, 30, 40, 50, 55, 60, 65, 70, or even 75 wt % of the first (meth)acrylate monomer, which includes all first (meth)acrylate monomers that meet the requisite Tg. In one embodiment, the polymeric microspheres are derived from at most 70, 75, 80, 85, 90, 95, or even 99 wt % of the first (meth)acrylate monomer, which includes all first (meth)acrylate monomers that meet the requisite Tg. The amount of the first (meth)acrylate used to make the plurality of polymeric microspheres can be adjusted based on the application.

The polar (meth)acrylate monomer is acrylic acid, hydroxyethyl acrylate, N-methyl acrylamide, or any monomer having a sidechain containing at least one of the following: alcohol, carboxylic acid, amine, amide, imide, thiol, ester, phosphate, or combinations thereof. Exemplary polar monomers include: acrylic acid, methacrylic acid, itaconic acid, fumaric acid, crotonic acid, citraconic acid, and maleic acid, hydroxyalkyl acrylates(meth)acrylates such as 4-hydroxylbutyl(meth)acrylate and hydroxy ethyl (meth)acrylate, acrylamides and substituted acrylamides (such as N,N-dialkylaminoalkyl (meth)acrylates and tert-octylacrylamide), acrylamines and substituted acrylamines, lactams and substituted lactams, O-carboxyethylacrylate, N-vinyl-2-pyrrolidone, N-vinyl caprolactam, acrylonitrile, and any combinations or mixtures thereof. In one embodiment, the polymeric microspheres are derived from at least 1, 2, 4, or even 5 wt % and at most 20, 15, or even 10 wt % of the polar (meth)acrylate monomer. Although not wanting to be limited by theory, it is believed that the polar (meth)acrylate monomer, which polymerizes into the microspheres enables the microspheres to interact with the (meth)acrylate matrix, enhancing the strength (e.g., as determined by higher peak stress in dynamic shear) of the composite.

In one embodiment, additional comonomers may be used in addition to the first (meth)acrylate monomer and the polar (meth)acrylate monomer. In one embodiment, the additional comonomers are those monomers that have a Tg lower than room temperature. These comonomers, when polymerized with the first (meth)acrylate monomers, result in a copolymer having a Tg of room temperature or above. Exemplary additional comonomers include: 2-ethyl hexyl (meth)acrylate and n-butyl acrylate.

The polymeric microspheres may be made using techniques known in the art. In one embodiment, the polymeric microspheres can be made via suspension polymerization of a reaction mixture comprising the first (meth)acrylate monomer, the polar (meth)acrylate monomer, optional comonomers, and a stabilizer. In some embodiments, a suspension of monomers is formed, and polymerization is carried out using thermal initiation. The suspension may be a water-in-oil or an oil-in-water suspension. In some such embodiments, the suspension is an oil-in-water suspension, wherein the monomers are stabilized in a bulk water phase by employing one or more stabilizers. Stabilizers useful in embodiments of the present disclosure can include, for example, inorganic stabilizers, surfactants, polymer additives, or combinations thereof.

In some embodiments, the stabilizer may be an inorganic stabilizer such as those used in Pickering emulsion polymerizations (e.g., colloidal silica).

In some embodiments, the stabilizer may be a polymer additive. Polymer additives useful in embodiments of the present disclosure may include, for example, polyacrylamide, polyvinyl alcohol, partially acetylated polyvinyl alcohol, hydroxyethyl cellulose, N-vinyl pyrrolidone, carboxymethyl cellulose, gum arabic, or mixtures thereof. In some embodiments, the polymer additive includes those sold under the trade designation “SUPERFLOC” (e.g., “SUPERFLOC N-300”) by Kemira Oyj, Helsinki, Finland.

In some embodiments, the stabilizer may be a surfactant. In some embodiments, the surfactant may be anionic, cationic, zwitterionic, or nonionic in nature and the structure thereof not otherwise particularly limited. In some embodiments, the surfactant is a monomer and becomes incorporated within the polymer microsphere molecules. In other embodiments, the surfactant is present in the polymerization reaction vessel, but is not incorporated into the polymer microsphere.

Non-limiting examples of anionic surfactants useful in embodiments of the present disclosure include sulfonates, sulfolipids, phospholipids, stearates, laurates, or sulfates. Sulfates useful in embodiments of the present disclosure include sulfates sold under the trade designation “STEPANOL” by the Stepan Company, Northfield IL, or “HITENOL” by the Montello, Inc., Tulsa, OK.

Non-limiting examples of nonionic surfactants useful in embodiments of the present disclosure include block copolymers of ethylene oxide and propylene oxide, such as those sold under the trade designations “PLURONIC”, “KOLLIPHOR”, or “TETRONIC”, by the BASF Corporation of Charlotte, NC; ethoxylates formed by the reaction of ethylene oxide with a fatty alcohol, nonylphenol, dodecyl alcohol, and the like, including those sold under the trade designation “TRITON”, by the Dow Chemical Company of Midland, MI; oleyl alcohol; sorbitan esters; alkylpolyglycosides such as decyl glucoside; sorbitan tristearate; and combinations of one or more thereof.

Non-limiting examples of cationic surfactants useful in embodiments of the present disclosure include cocoalkylmethyl[polyoxyethylene (15)]ammonium chloride, benzalkonium chloride, cetrimonium bromide, demethyldioctadecylammonium chloride, lauryl methyl gluceth-10 hydroxypropyl diammonium chloride, tetramethylammonium hydroxide, monoalkyltrimethylammonium chlorides, monoalkyldimethylbenzylammonium chlorides, dialkylethylmethylammonium ethosulfates, trialkylmethylammonium chlorides, polyoxyethylenemonoalkylmethylammonium chlorides, and diquaternaryammonium chlorides; the ammonium functional surfactants sold by Akzo Nobel N.V. of Amsterdam, the Netherlands, under the trade designations “ETHOQUAD”, “ARQUAD”, and “DUOQUAD”; or mixtures thereof.

In some embodiments, where a stabilizer is employed in an oil-in-water suspension polymerization reaction, it is employed in an amount of at least 0.01, 0.05, 0.1, 0.5, or even 1.0 wt %, based on the total weight of solids in the aqueous polymerizable reaction mixture. In some embodiments where a stabilizer is employed in an oil-in-water suspension polymerization reaction, it is employed in an amount of up to 4.0 or even 5.0 wt %, based on the total weight of solids in the aqueous polymerizable pre-adhesive reaction mixture.

In some embodiments, a cross-linking agent may be used in the microsphere reaction mixture to modify the properties of the resultant microspheres. Nonlimiting examples of suitable cross-linking agents include multifunctional (meth)acrylate(s), e.g., butanediol diacrylate or hexanediol diacrylate, or other multifunctional cross-linkers such as divinylbenzene and mixtures thereof. In some embodiments, at least 0.005, 0.01, 0.02, 0.05, or even 0.08 wt % of the cross-linker is used based on the total weight of monomers used in the polymerization of the polymeric microspheres. In some embodiments, at most 0.1, 0.2, 0.5, 1, 2, or even 5 wt % of the cross-linker is used based on the total weight of monomers used in the polymerization of the polymeric microspheres.

In some embodiments, an initiator is used that will generate cross-linking in situ by abstracting hydrogens from the polymer in the microspheres allowing cross-linking. Such initiators can include: some peroxide initiators such as benzoyl peroxide and/or azo initiators. Typically, these cross-linking initiators are used in concentrations similar to the cross-linking agent described above (e.g., 0.005 to 5 wt %).

The polymerization of the aqueous polymerizable reaction mixture may be carried out using conventional suspension polymerization techniques familiar to those of ordinary skill in the relevant arts.

In some embodiments where thermal decomposition is employed to initiate polymerization, suspension polymerization of the monomers employed to make the polymer microspheres of the present disclosure may be carried out by blending the stabilizer(s) with water to provide an aqueous phase and blending the monomer composition and a thermal initiator to provide an oil phase. The aqueous phase and the oil phase may then be combined and stirred vigorously enough to form a suspension. The suspension may generally be formed, for example, by stirring the combined aqueous and oil phases with a 3-blade or 4-blade stirrer at a speed of 500 to 1500 (e.g. 1000) revolutions per minute (“rpm”). In some instances, high shear mixing may be used to generate smaller particle sizes such as those less than 10 μm (micrometers). Exemplary speeds include those a 5000, 10,000, 20,000 or even 50,000 rpm. In some embodiments, a static shear mixer may be used. The suspension may then be heated to a temperature wherein decomposition of the initiator occurs at a rate suitable to sustain a suitable rate of polymerization (e.g., 60° C.).

Non-limiting examples of suitable thermal initiators include organic peroxides or azo compounds conventionally employed by those skilled in the art of thermal initiation of polymerization, such a dicumyl peroxide, benzoyl peroxide, or 2,2′-azo-bis(isobutyronitrile) (“AIBN”) and thermal initiators sold under the trade designation “VAZO” by Chemours Canada Company, ON, Canada. In some embodiments an oil-soluble initiator (e.g., 2-2′-azobis(2,4-dimethylvaleronitrile)) is preferred. The amount of initiator is typically in a range of 0.05 to 2 wt % or in a range of 0.05 to 1 wt %, or in a range of 0.05 to 0.5 wt % based on the total weight of monomers used to prepare the polymeric microspheres.

In some embodiments, water is present in the polymerizable reaction mixture, for example, in an amount of at least 35, 40, 45, or even at least 50 wt %. In some embodiments, water is present in the polymerizable reaction mixture, for example, in an amount of up to 90, 80, 70, or even 60 wt %.

In some such embodiments, the temperature of the suspension is adjusted prior to and during the polymerization is 30° C. to 100 C, or 40 C to 80 C, or 40 C to 70 C, or to 45° C. to 65° C. In some embodiments, the peak temperature during the exotherm may reach as high as 75, 90, or even 110° C.

Agitation of the suspension at elevated temperature is carried out for a suitable amount of time to decompose substantially all of the thermal initiator and react substantially all of the monomers added to the suspension to form a polymerized suspension. In some embodiments, elevated temperature is maintained for a period of 1 hour to 48 hours, 2 hours to 24 hours, or 4 hours to 18 hours, or 8 hours to 16 hours.

During polymerization, it may be necessary in some embodiments to add additional thermal initiator to complete the reaction of substantially all of the monomer content added to the reaction vessel to prepare the microspheres. It will be appreciated that completion of the polymerization is achieved by careful adjustment of conditions, and standard analytical techniques, such as gas chromatographic analysis of residual monomer content, will inform the skilled artisan regarding the completion of polymerization of the polymeric microspheres.

In other embodiments, the polymerization of the microspheres may occur in an aqueous mixture that may also include an organic solvent. Examples of suitable organic solvents and solvent mixtures include, in various embodiments, one or more of ethanol, methanol, toluene, methyl ethyl ketone, ethyl acetate, isopropyl alcohol, tetrahydrofuran, 1-methyl-2-pyrrolidinone, 2-butanone, acetonitrile, dimethylformamide, dimethyl sulfoxide, dimethylacetamide, dichloromethane, t-butanol, methyl isobutyl ketone, methyl t-butyl ether, and ethylene glycol. If used, between 30 to 70 wt % organic solvent is used in the microsphere reaction mixture.

Following polymerization, the thus obtained polymeric microspheres can be collected using conventional means such as filtering, optionally washed, and dried.

The particles of the present disclosure are typically spherical-shaped particles. In preferred embodiments, polymeric microspheres of the present disclosure have an average particle diameter of at least 1, 5, 10, 20, 30, 40, or even 50 micrometers (μm). In some embodiments, the polymeric microspheres of have an average particle size at most 60, 80, 90, 100, 120, 150, 180, or even 200 m. The particle size may be measured by conventional means using, for example, a Horiba LA 910 particle size analyzer (Horiba, Ltd, Kyoto, Japan).

Depending on the selection of the monomers used to synthesis the polymeric microspheres, the polymeric microspheres may or may not be tacky (i.e., sticky). Preferably, the polymeric microspheres are non-tacky and behave as a powder, whereas the tacky polymeric microspheres tend to stick together more. Generally, the more high Tg monomer present, the less tacky the polymeric microsphere. Because a majority of the monomers used to synthesize the polymeric mircospheres have a higher Tg, the polymeric microspheres of the present disclosure are comprised of an amorphous polymer. In one embodiment, the polymeric microspheres disclosed herein have a Tg of at least 20, 25, or even 30° C. In one embodiment, the polymeric microspheres disclosed herein have a Tg of at most 30, 50, 70, 100, 125, or even 150° C.

In the present disclosure, the plurality of microspheres are dispersed in a (meth)acrylate-based matrix to form a composite adhesive.

### (Meth)Acrylate-Based Matrix

The matrix of the pressure sensitive adhesive of the present disclosure is (meth)acrylate-based, derived from a (meth)acrylate macromer and a second (meth)acrylate monomer.

The (meth)acrylate macromer included in the polymerizable components used to form the (meth)acrylate-based matrix has a (meth)acryloyloxy group plus (i) a poly(ethylene oxide) group, (ii) poly(propylene oxide) group, (iii) poly(ethylene oxide-co-propylene oxide) group, which can also be referred to as a poly(ethylene glycol), poly(propylene glycol), or poly(ethylene glycol-co-propylene glycol) groups respectively, (iv) a poly(tetrahydrofuran) group, or (v) combinations thereof. If the macromer contains a poly(ethylene oxide) group, it can be referred to as a poly(ethylene oxide) (meth)acrylate. If the macromer contains a poly(propylene oxide) group, it can be referred to as a poly(propylene oxide) (meth)acrylate. If the macromer contains a poly(ethylene oxide-co-propylene oxide) group, it can be referred to as a poly(ethylene oxide-co-propylene oxide) (meth)acrylate, which is a copolymer. If the macromer contains a poly(tetrahydrofuran) group, it can be referred to as a poly(tetrahydrofuran) (meth)acrylate.

The (meth)acrylate macromer typically has a number average molecular weight in a range of 350 to 10,000 Daltons. For example, the (meth)acrylate macromer has a number average molecular weight no greater than 10,000, 8000, 6000, 4000, 2000, 1000, 800, 650, or even 500 Daltons. The number average can be determined by gel permeation chromatography using techniques known in the art.

The (meth)acrylate macromer often has a Tg (as measured using a homopolymer of the macromer) that is no greater than −10° C. For example, the glass transition temperature can be no greater than −10, −20, −30, or even −40° C. In one embodiment, the Tg is less than −70 or even −80° C. Such a low macromer Tg imparts compliance and flexibility to the (meth)acrylate copolymer and to the adhesive composition.

Examples of such commercially available (meth)acrylate macromers include poly(ethylene glycol) methyl ether acrylate, such as that having a reported number average molecular weight (Mn) of 480 Daltons (available from Sigma-Aldrich) and poly(propylene glycol) acrylate, such as that having a reported number average molecular weight of 475 Daltons (available from Sigma-Aldrich). Other suitable macromers are available under the trade designation BISOMER from Geo Specialty Chemicals, Ambler, PA, such as BISOMER PPA6 (poly(propylene glycol) acrylate reported to have a number average molecular weight of 420 Daltons), BISOMER PEM63P HD (a mixture of poly(ethylene glycol) methacrylate and poly(propylene glycol) reported to have a number average molecular weight of 524 Daltons), BISOMER PPM5 LI (poly(propylene glycol) methacrylate reported to have a number average molecular weight of 376 Daltons), BISOMER PEM6 LD (poly(ethylene glycol) methacrylate reported to have a number average molecular weight of 350 Daltons), BISOMER MPEG350MA (methoxy poly(ethylene glycol) methacrylate) reported to have a number average molecular weight of 430 Daltons), and BISOMER MPEG550MA (methoxy poly(ethylene glycol) methacrylate reported to have a number average molecular weight of 628 Daltons). Other suitable macromers are available under the trade designation MIRAMER from Miwon Specialty Chemical Company, Gyeonggi-do, Korea, such as MIRAMER M193 MPEG600MA (methoxy poly(ethylene glycol) methacrylate reported to have a number average molecular weight of 668 Daltons, MIRAMER M164 (nonyl phenol poly(ethylene glycol) acrylate reported to have a number average molecular weight of 450 Daltons), MIRAMER M1602 (nonyl phenol poly(ethylene glycol) acrylate reported to have a number average molecular weight of 390 Daltons), and MIRAMER M166 (nonyl phenol poly(ethylene glycol) acrylate reported to have a number average molecular weight of 626 Daltons. Still other suitable macromers are available from Sans Esters Corporation, New York, NY such as MPEG-A400 (methoxy poly(ethylene glycol) acrylate reported to have a number average molecular weight of 400 Daltons), and MPEG-A550 (methoxy poly(ethylene glycol) acrylate reported to have a number average molecular weight of 550 Daltons. Various combinations of such macromers may be used if desired.

The macromer having the poly(tetrahydrofuran) group can be prepared, for example, by polymerizing tetrahydrofuran using cationic polymerization. More specifically, the polymerization reaction can occur at room temperature (e.g., 20 to 25° C.) using trifluoromethanesulfonate as the initiator to form an intermediate (A) was reacted with water to produce poly(tetramethyleneglycol) monomethyl ether, which was further reacted with 2-vinyl-4,4-dimethylazlactone to produce a PTHF-VDM macromer. The weight average molecular weight of the poly(tetrahydrofuran) (meth)acrylate macromer is typically in a range of 350 to 10,000 Daltons, which can be determined using known methods such as gel permeation chromatography with polystyrene standards. If the molecular weight is higher, it may not be miscible with the other components in the polymerizable composition and/or it may crystallize before, during, or after polymerization of the matrix. In many embodiments, the poly(tetrahydrofuran) (meth)acrylate macromer has a weight average molecular weight of at least 500, 600, 800, 1,000, 2,000 or even 3,000 Daltons and up to 10,000, 8,000, 6,000, 5,000, or even 3,000 Daltons.

The second (meth)acrylate monomer in the polymerizable matrix is a C₁ to C₂₀ (meth)acrylate ester monomer. Useful C₁ to C₂₀ (meth)acrylate ester monomers include at least one monofunctional (meth)acrylate ester of a linear, branched, and/or cyclic non-tertiary alkyl alcohol, the alkyl group of which comprises at least 1, 2, 3, 4, 5, 6, 7, 8 or even 10 carbon atoms; and at most 14, 16, 18 or even 20 carbon atoms. In one embodiment, the (meth)acrylate ester monomer comprises 1 to 20 carbon atoms. Exemplary second (meth)acrylate monomers include, methyl (meth)acrylate, ethyl (meth)acrylate, n-propyl (meth)acrylate, isopropyl (meth)acrylate, butyl acrylate, 2-methyl butyl acrylate, n-butyl acrylate, isobutyl acrylate, tert-butyl (meth)acrylate, 2-ethylhexyl acrylate, n-pentyl (meth)acrylate, iso-pentyl (meth)acrylate, n-hexyl (meth)acrylate, iso-hexyl (meth)acrylate, cyclohexyl (meth)acrylate, phenyl (meth)acrylate, n-octyl (meth)acrylate, iso-octyl (meth)acrylate, 2-octyl(meth)acrylate, 2-ethylhexyl (meth)acrylate, decyl (meth)acrylate, lauryl (meth)acrylate, 2-propylheptyl (meth)acrylate, stearyl (meth)acrylate, isobornyl (meth)acrylate, benzyl (meth)acrylate, octadecyl acrylate, nonyl acrylate, dodecyl acrylate, isophoryl (meth)acrylate, dodecyl (meth)acrylate, and any combinations or mixtures thereof.

In one embodiment, the second (meth)acrylate monomer used for the matrix is copolymerized with polar copolymerizable monomers. The polar copolymerizable monomers can be acid or non-acid functional polar monomers such as acrylic acid, hydroxyethyl acrylate, N-methyl acrylamide, or any monomer having a sidechain containing at least one of the following: alcohol, carboxylic acid, amine, amide, imide, thiol, ester, phosphate, and combinations thereof. Exemplary polar monomers include: acrylic acid, methacrylic acid, itaconic acid, fumaric acid, crotonic acid, citraconic acid, and maleic acid, hydroxyalkyl acrylates, acrylamides and substituted acrylamides (such as N,N-dialkylaminoalkyl (meth)acrylates), acrylamines and substituted acrylamines, lactams and substituted lactams, β-carboxyethylacrylate, N-vinyl-2-pyrrolidone, N-vinyl caprolactam, acrylonitrile, and any combinations or mixtures thereof.

When copolymerized with strongly polar monomers, the second (meth)acrylate monomer generally comprises at least about 75 wt % of the polymerizable monomer composition for the matrix. When copolymerized with moderately polar monomers, the (meth)acrylate ester monomer generally comprises at least about 50 wt % of the polymerizable monomer composition for the matrix. Strongly polar monomers include monoolefinic mono- and dicarboxylic acids, hydroxy alkyl acrylate, cyanoalkyl acrylates, acrylamides or substituted acrylamides. Moderately polar monomers include N-vinyl pyrrolidone, acrylonitrile, vinyl chloride or diallyl phthalate. The strongly polar monomer preferably comprises up to about 25 wt %, more preferably up to about 15 wt %, of the polymerizable monomer composition for the matrix. The moderately polar monomer preferably comprises up to about 30 wt %, more preferably from about 5 wt % to about 30 wt % of the polymerizable monomer composition for the matrix.

Additional monomers may be added to the polymerizable matrix composition to alter the performance of the matrix in the adhesive, such as a non-polar monomer. The non-polar monomer may be a non-polar ethylenically unsaturated monomer selected from monomers comprising a hydrocarbon sidechain. Examples of suitable non-polar comonomers include 3,3,5-trimethylcyclohexyl acrylate, cyclohexyl acrylate, n-octyl acrylamide, t-butyl acrylate, methyl methacrylate, ethyl methacrylate, or combinations thereof.

A cross-linking agent is used to create a three-dimensional polymer network and to achieve high internal strength of the (meth)acrylate-based matrix within the adhesive. Useful cross-linking agents include photosensitive cross-linking agents, which are activated by ultraviolet (UV) light. Useful cross-linking agents include: multifunctional (meth)acrylates, triazines, or combinations or mixtures thereof. Exemplary cross-linking agents include substituted triazines such as 2,4,-bis(trichloromethyl)-6-(4-methoxy phenyl)-s-triazine, 2,4-bis(trichloromethyl)-6-(3,4-dimethoxyphenyl)-s-triazine, and the chromophore-substituted halo-s-triazines disclosed in U.S. Pat. Nos. 4,329,384 and 4,330,590 (Vesley). Other useful cross-linking agents include multifunctional alkyl acrylate monomers such as trimetholpropane triacrylate, pentaerythritol tetra-acrylate, 1,2 ethylene glycol diacrylate, 1,4 butanediol diacrylate, 1,6 hexanediol diacrylate, and 1,12 dodecanol diacrylate. Various other cross-linking agents with different molecular weights between (meth)acrylate functionality may also be useful.

In the present disclosure, the (meth)acrylic ester (such as a C₁ to C₂₀ (meth)acrylate ester) monomer, the (meth)acrylate macromer, and any optional comonomer are polymerized to form the (meth)acrylate-based matrix.

In one embodiment, the polymer of the matrix comprises at least 10, 20, 30, 40, 50, 60, 70, or even 75% by weight; at most 80, 85, 90, 95, 97, or even 99.5% by weight of a C₁ to C₂₀ (meth)acrylate ester monomer relative to the other monomers. A higher amount of the C₁ to C₂₀ (meth)acrylate ester monomer relative to the other comonomers affords adequate adhesion at low temperatures (e.g., below room temperature) and/or higher debonding rates (e.g., >12 in/min).

Optionally, the polymer of the matrix comprises at least 0.5, 1.0, 2.5, 5, 8, or even 10% by weight; at most 15, 18, 20, 25, 30, 35, 40, 45, or even 50% by weight of a polar monomer relative to the other monomers present in the (meth)acrylate-based matrix.

In one embodiment, the (meth)acrylate-based matrix contains at least 5, 10, 15, 20, 25, 30, or even 35 weight percent, and up to 60, 55, 50, 45, or even 40 weight percent of the (meth)acrylate macromer. The amount of (meth)acrylate macromer used is based on the total weight of polymerizable components in the matrix.

In one embodiment, a cross-linking agent (e.g., a multifunctional acrylate) may be added at a level of at least 0.01, 0.1, 0.5, 1.0, 1.5, or even 2% weight solids; at most 3, 4, 5, 6, 8, or even 10% weight solids per the total weight of all of the monomers and macromer used in the preparation of the (meth)acrylate-based matrix. In another embodiment, an initiator is used that will generate cross-linking in situ by abstracting hydrogens from the polymer in the matrix allowing cross-linking of the (meth)acrylate-based matrix. Typically, a cross-linking initiator is used in concentrations of at least 0.01, 0.1, 0.5, 1.0, 1.5, or even 2% weight by solid; at most 3, 4, 5, 6, 8, or even 10% weight by solid per total weight of all of the monomers used in the preparation of the (meth)acrylate-based matrix.

In one embodiment, the polymer in the (meth)acrylate-based matrix has a weight average molecular weight of at least 100,000; 200,000; 300,000; 400,000; 500,000; 750,000; or even 1,000,000 Daltons; at most 20,000,000; 25,000,000; or even 30,000,000 Daltons. The molecular weight of the polymer can be determined by gel permeation chromatography as is known in the art. The polymer typically has a molecular weight dispersity that can be calculated as the weight average molecular weight versus the number average molecular weight of the polymer. The inherent viscosity is related to the molecular weight of the polymer, but also includes other factors, such as concentration of the polymer. In the present disclosure, the inherent viscosity of the polymer may be at least 0.4, 0.45, 0.5, 0.6, 0.7, or even 0.8; at most 0.7, 0.8, 1.0, 1.2, 1.4, 1.6, 1.8 or even 2,3 as measured in ethyl acetate at a concentration of 0.15 grams/deciliter (g/dL).

The molecular weight of the polymer in the (meth)acrylate-based matrix may be controlled using techniques known in the art. For example, during polymerization, a chain transfer agent may be added to the monomers to control the molecular weight. Useful chain transfer agents include, for example, those selected from the group consisting of carbon tetrabromide, alcohols, mercaptans, or mixtures thereof. Exemplary chain transfer agents are isooctylthioglycolate and carbon tetrabromide. At least 0.01, 0.05, 0.1, 0.15, 0.2, 0.3, or even 0.4% weight of a chain transfer agent may be used; at most 0.1, 0.2, 0.3, 0.4, 0.5, or even 0.6% weight of a chain transfer agent may be used based the weight of all of the monomers used in preparation of the (meth)acrylate-based matrix.

The (meth)acrylate-based matrix used in the adhesive of the present disclosure may be polymerized by techniques known in the art, including, for example, the conventional techniques of solventless polymerization. The polymerization of the monomers “substantially solvent free”, that less than 5%, 2%, 1% or even 0.5% by weight of solvent is used based on the weight of the monomers, and more preferably no additional solvent is added during the polymerization. The term “solvent” refers both to water and to conventional organic solvents used in the industry which are volatilized in the process.

The (meth)acrylate-based matrix, which is the other component of the adhesive composition, plays a role of bonding between two adherends and may be tacky at ordinary temperature, or may not be initially tacky and adhesion builds over time.

### Composite Adhesive

Described below is more detail on the preparation of the composite adhesive according to the present disclosure.

The mixture of plurality of polymeric microspheres along with the polymerizable matrix including the (meth)acrylate macromer and the second (meth)acrylate monomer along with optional comonomers can be polymerized by various techniques, with photoinitiated bulk polymerization being preferred. An initiator is preferably added to aid in polymerization of the monomers or pre-polymerized syrup. The type of initiator used depends on the polymerization process. In a preferred embodiment, photoinitiators are used to initiate the polymerization of the matrix. Photoinitiators that are useful for polymerizing the acrylate monomers include benzoin ethers such as benzoin methyl ether or benzoin isopropyl ether, substituted benzoin ethers such as 2-methyl-2-hydroxypropiophenone, aromatic sulfonyl chlorides such as 2-naphthalenesulfonyl chloride, or photoactive oxides such as 1-phenyl-1,2-propanedione-2-(o-ethoxycarbonyl)oxime. An example of a commercially available photoinitiator is “IRGACURE 651” available from Ciba, having a formula of 2,2-dimethoxy-1,2-diphenylethane-1-one. Generally, the photoinitiator is present in an amount of about 0.005 to 1 weight percent based on the weight of the monomers in the matrix. In another embodiment, a thermal initiator may be used, such as for example, AIBN (azobisisobutyronitrile) and/or peroxides. The polymerization may be carried out in the presence of at least one free-radical initiator. Useful free-radical UV initiators include, for example, benzophenones.

In a preferred practice of the disclosure, the polymeric microspheres are blended with the acrylate monomers or an acrylic syrup (which becomes part of the (meth)acrylate-based matrix). As used herein a syrup refers to a mixture that has been thickened to a coatable viscosity, i.e., preferably between about 300 and 10,000 centipoise or higher depending upon the coating method used, and include mixtures in which the monomers are partially polymerized to form the syrup, and monomeric mixtures which have been thickened with fillers such as silicas and the like.

The composite compositions of the present disclosure (i.e., comprising the polymeric microspheres and the acrylate monomers or acrylic syrup used to from the (meth)acrylate-based matrix) may be irradiated with activating ultraviolet (UV) radiation having a UV A maximum in the range of 280 to 425 nanometers to polymerize the monomer component(s). UV light sources can be of various types. Low light intensity sources, such as blacklights, generally provide intensities ranging from 0.1 or 0.5 mW/cm² (millwatts per square centimeter) to 10 mW/cm² (as measured in accordance with procedures approved by the United States National Institute of Standards and Technology as, for example, with a UVIMAP UM 365 L-S radiometer manufactured by Electronic Instrumentation & Technology, Inc., in Sterling, VA). High light intensity sources generally provide intensities greater than 10, 15, or 20 mW/cm² ranging up to 450 mW/cm² or greater. In some embodiments, high intensity light sources provide intensities up to 500, 600, 700, 800, 900 or 1000 mW/cm². UV light to polymerize the monomer component(s) can be provided by various light sources such as light emitting diodes (LEDs), blacklights, medium pressure mercury lamps, etc. or a combination thereof. The composite composition can also be polymerized with higher intensity light sources as available from Fusion UV Systems Inc., Gaithersburg, MD. The UV exposure time for polymerization and curing can vary depending on the intensity of the light source(s) used. For example, complete curing with a low intensity light course can be accomplished with an exposure time ranging from about 30 to 300 seconds; whereas complete curing with a high intensity light source can be accomplished with shorter exposure time ranging from about 5 to 20 seconds. Partial curing with a high intensity light source can typically be accomplished with exposure times ranging from about 2 seconds to about 5 or 10 seconds.

Preferably, the syrups of the of the present disclosure are formed by partial polymerization of the monomers by free radical initiators, which are known in the art and can be activated by thermal energy or radiation such as ultraviolet light. In some instances, it may be preferred to add additional monomer to the syrup, as well as further photoinitiator and other additives. An effective amount of at least one free radical initiator is added to the (meth)acrylate monomers or syrup comprising the polymeric microspheres. The mixture is then coated onto a substrate such as a transparent polyester film, which may optionally be coated with a release coating, and exposed to UV radiation in a nitrogen rich atmosphere to form an adhesive. Alternatively, oxygen can be excluded by overlaying the coated adhesive with a second release coated polyester film and exposed to UV radiation. Subsequent exposure of the adhesive to a second source of energy can be used to cross-link or further cure the adhesive. Such sources of energy include heat, electron beam, gamma radiation, and high intensity ultraviolet lamps, such as mercury are lamps.

The adhesives of the present disclosure can also be prepared by bulk polymerization methods in which the macromer and monomers for the (meth)acrylate-based matrix, the polymeric microspheres, the cross-linking agent, the free radical initiator, and optional additional components described below is coated onto a flat substrate such as a polymeric film and exposed to an energy source, such as a UV radiation source, in a low oxygen atmosphere, i.e., less than 1000 parts per million (ppm), and preferably less than 500 ppm, until the polymerization is substantially complete, i.e., residual monomers are less than 10%, and preferably less than 5%.

Alternatively, a sufficiently oxygen free atmosphere can be provided by enclosing the polymerizable composite composition with, for example, a polymeric film. In one embodiment, the film can be overlaid on top of the coated adhesive composition before polymerization. In another embodiment, the adhesive composition is placed in receptacles, which can be optionally sealed, and then exposed to energy, such as heat or ultraviolet radiation to cross-link the adhesive. The adhesive can then either be dispensed from the receptacles for use, or the receptacles can be fed to a hot melt coater and coated onto a substrate to make tapes or other types of adhesive coated substrates (e.g., labels). In the latter case, the receptacle material should be hot melt coatable with the adhesive in the receptacle, and the receptacle material does not deleteriously affect the desired end properties of the adhesive.

The composite adhesive composition may comprise additional components to impact the performance and/or properties of the composition. Such additives include plasticizers, tackifiers, antistatic agents, colorants, antioxidants, pigments, dyes, fungicides, bactericides, anti-corrosion additive (e.g., benzotriazole derivatives), organic and/or inorganic filler particles, or the like. Use of such additives is well known to those of ordinary skill in the art. In one embodiment, the additives are present at amounts such that the solids in the curable adhesive composition (or the cured adhesive) comprise at least 65 wt % of the (meth)acrylate-based matrix. Therefore, the total amount of additives should be less than 35, 30, 25, 20, 10, 5, or even 1 wt % of the solids. Certain additives may be of lower weight percent, e.g., a pigment may be added at less than 0.05% or even less than 0.005% by weight solids. In some embodiments, such as the instance of inorganic fillers, large amounts of the inorganic fillers may be used (for example greater than 60, 70, 80 or even 95 wt % solids).

Exemplary tackifier include: C5-resins, terpene phenol resins, (poly)terpenes and rosin esters, hydrogenated hydrocarbons, and non-hydrogenated hydrocarbon resins. When used, the tackifiers may be added at a level of at least 5, 8, 10, or even 12 parts; and at most 15, 20, 25, or even 30 parts per 100 parts versus the weight of all of the (meth)acrylate-based matrix.

In one embodiment, the adhesive composition comprises an ionic liquid. The presence of an ionic liquid may be useful in easing the peeling (or peel-ability) of the adhesive when reworking or recycling an article. An ionic liquid is a unique salt, which is in a liquid state at about 100° C. or less, has negligible vapor pressure, and high thermal stability. The ionic liquid is composed of a cation and an anion and has a melting point of no more than 100° C., (i.e., being a liquid at about 100° C. or less), about 95° C. or less, or even about 80° C. or less. Certain ionic liquids exist in a molten state even at ambient temperature since their melting points are less than room temperature, and therefore they are sometimes referred to as ambient temperature molten salts. The cation and/or anion of the ionic liquid are relatively sterically-bulky, and typically one and/or both of these ions are an organic ion. The ionic liquid can be synthesized by known methods, for example, by a process such as anion exchange or metathesis process, or via an acid-base or neutralization process.

The cation of the ionic liquid of the present disclosure may be a nitrogen-containing cation, a phosphonium ion, a sulfonium ion or the like, including various delocalized heteroaromatic cations, but is not limited thereto. The nitrogen-containing cation includes ions such as, alkylammonium, imidazolium, pyridinium, pyrrolidinium, pyrrolinium, pyrazinium, pyrimidinium, triazonium, triazinium, quinolinium, isoquinolinium, indolinium, quinoxalinium, piperidinium, oxazolinium, thiazolinium, morpholinium, or piperazinium. Examples of the phosphonium ion include tetraalkylphosphonium, arylphosphonium, or alkylarylphosphonium. Examples of the sulfonium ion include alkylsulfonium, arylsulfonium, thiophenium, or tetrahydrothiophenium. The alkyl group directly bonded to nitrogen atom, phosphorus atom, or sulfur atom may be a linear, branched or cyclic alkyl group having a carbon number of at least 1, 2, or even 4 and not more than 8, 10, 12, 15, or even 20. The alkyl group may optionally contain heteroatoms such as 0, N, and/or S in the chain or at the end of the chain (e.g., a terminal —OH group). The aryl group directly bonded to nitrogen atom, phosphorus atom, or sulfur atom may be a monocyclic or condensed cyclic aryl group having at least 5, 6, or even 8 carbon atoms and not more than 12, 15, or even 20 carbon atoms. An arbitrary site in the structure constituting such a cation may be further substituted by an alkyl group, an alkenyl group, an alkynyl group, a cycloalkyl group, an aryl group, an aralkyl group, an arylalkyl group, an alkoxy group, an aryloxy group, a hydroxyl group, a carbonyl group, a carboxyl group, an ester group, an acyl group, an amino group, a dialkylamino group, an amide group, an imino group, an imide group, a nitro group, a nitrile group, a sulfide group, a sulfoxide group, a sulfone group, a halogen atom or the like. A heteroatom such as oxygen atom, nitrogen atom, sulfur atom, and/or silicon atom may be contained in the main chain or ring of the structure constituting the cation.

Specific examples of the cation include N-ethyl-N′-methylimidazolium, N-methyl-N′-butylimidazolium, N-methyl-N-propylpiperidinium, N,N,N-trimethyl-N-propylammonium, N-methyl-N,N,N-tripropylammonium, N,N,N-trimethyl-N-butylammoniuim, N,N,N-trimethyl-N-methoxyethylammonium, N-methyl-N,N,N-tris(methoxyethyl)ammonium, N,N-dimethyl-N-butyl-N-methoxyethylammonium, N,N-dimethyl-N,N-dibutylammonium, N-methyl-N,N-dibutyl-N-methoxyethylammonium, N-methyl-N,N,N-tributylammonium, N,N,N-trimethyl-N-hexylammonium, N,N-diethyl-N-methyl-N-(2-methoxyethyl)ammonium, 1-propyl-tetrahydrothiophenium, 1-butyl-tetrahydrothiophenium, 1-pentyl-tetrahydrothiophenium, 1-hexyl-tetrahydrothiophenium, glycidyltrimethylammonium, N-ethylacryloyl-N,N,N-trimethylammonium, N-ethyl-N-methylmorphonium, N,N,N-trioctylammonium, N-methyl-N,N,N-trioctylammonium, N,N-dimethyl-N-octyl-N-(2-hydroxyethyl)ammonium, triethylsulfonium, or mixtures thereof.

The anion of the ionic liquid of the present disclosure may be, for example, a sulfate (R—OSO₃⁻); a sulfonate (R—SO₃⁻); a carboxylate (R—CO₂⁻); a phosphate ((RO)₂P(═O)O⁻); a borate represented by the formula: BR₄⁻, such as tetrafluoroborate (BF₄⁻) and tetraalkylborate; a phosphate represented by the formula: PR₆⁻, such as hexafluorophosphate (PF₆⁻) and hexaalkylphosphate; an imide (R₂N⁻); a sulfonylimide; an imide, a methide (R₃C⁻); a nitrate ion (NO₃⁻); a nitrite ion (NO₂⁻); a dicyanamide ((CN)₂N⁻), or a halide such as iodide. In the formulas listed above, each R may be independently a hydrogen atom, a halogen atom (fluorine, chlorine, bromine, iodine), a substituted or unsubstituted alkyl, alkenyl, alkynyl, cycloalkyl, aryl, aralkyl, arylalkyl, acyl or sulfonyl group, or the like. A heteroatom such as an oxygen atom, a nitrogen atom and a sulfur atom may be contained in the main chain or ring of the group R, and a part or all of hydrogen atoms on the carbon atom of the group R may be replaced with fluorine atoms. In the case where a plurality of R's are present in the anion, these R's may be the same or different.

In some embodiments, it is advantageous to use a perfluorinated ion, such as a perfluorinated anion to achieve excellent corrosion resistance and electro-debonding. However, the use of fluorinated ions should be balanced with the environmental impact of the finished good, as some fluorinated chemicals may have restricted use due to environmental concerns. Examples of an anion containing a perfluoroalkyl group, which can be used, include a bis(perfluoroalkylsulfonyl)imide ((RfSO₂)₂N⁻), a perfluoroalkylsulfonate (RfSO₃⁻) and a tris(perfluoroalkylsulfonyl)methide ((RfSO₂)₃C⁻) (wherein Rf represents a perfluoroalkyl group). The perfluoroalkyl group may comprise, for example, from at least 1, 2, 3 or even 4 to at most 8, 10, 12, 15, or even 20 carbon atoms. Specific examples of the bis(perfluoroalkylsulfonyl)imide include: bis(trifluoromethanesulfonyl)imide, bis(pentafluoroethanesulfonyl)imide, bis(heptafluoropropanesulfonyl)imide, or bis(nonafluorobutanesulfonyl)imide. Specific examples of the perfluoroalkylsulfonate include: trifluoromethanesulfonate, pentafluoroethanesulfonate, heptafluoropropanesulfonate, or nonafluorobutanesulfonate. Specific examples of the tris(perfluoroalkylsulfonyl)methide include: tris(trifluoromethanesulfonyl)methide, tris(pentafluoroethanesulfonyl)methide, tris(heptafluoropropanesulfonyl)methide, or tris(nonafluorobutanesulfonyl)methide. An example of a fluorinated anion not comprising a C—F bond is hexafluorophosphate, dicyanamide, and iodide.

As for the ionic liquid composed of the above-described cation and anion, 1-butyl-3-methylimidazolium bis(trifluoromethanesulfonyl)imide, tri-ethyl sulfonium bis(trifluoromethanesulfonyl)imide, 1-butyl-3-methylimidazolium hexafluorophosphate, 1-butyl-3-methylimidazolium iodide, ethyl pyridinium bis(trifluoromethanesulfonyl)imide, trimethyl ammonium ethyl acrylate bis(trifluoromethanesulfonyl)imide, 1-butyl-3-methylimidazolium dicyanamide, 1-ethyl-3-methylimidazolium dicyanamide, and/or a tetra alkyl ammonium with hydroxy functionality with bis(trifluoromethanesulfonyl)imide counterion, available under the trade designation “FC-5000” from 3M Co., Maplewood, MN can be advantageously used as the ionic liquid, because of their excellent removability during electro-debonding due to reduced bond strength upon application of electricity.

The ionic liquid may be added before, during, or after polymerization of the (meth)acrylate matrix. If an ionic liquid is used, the ionic liquid in the composite adhesive may be present in at least 0.5, 0.7, 0.8, 1, 1.5, or even 2 wt % and less than 2.5, 3, 4, 5, 6, 7, 8, 9, 10, 12, 15, or even 20 wt %. Enough ionic liquid should be added to enable electro-debonding, while too much ionic liquid may negatively impact the physical properties of the composite adhesive, such as shear, peel adhesion, and/or ability to survive the random free fall test. The type of ionic liquid used may impact how much can be added without negatively impacting the physical properties of the composite adhesive. For example, if the ionic liquid can be polymerized into (meth)acrylate matrix, for example, the ionic liquid comprises at least one (or even at least two) acrylate, methacrylate, or styrene functional group or combinations thereof, more ionic liquid may be incorporated into the composite adhesive. For example, the composite adhesive may comprise at least 0.5, 0.7, 0.8, 1, 1.5, or even 2 wt % and less than 2.5, 3, 4, 5, 6, 7, 8, 9, 10, 12, 15, or even 20 wt % of a polymerizable ionic liquid. If the ionic liquid is not polymerizable into the (meth)acrylate matrix of the composite adhesive, less ionic liquid should be used due to it negatively impacting the physical properties of the composite adhesive (such as static shear performance). For example, the composite adhesive may comprise at least 0.7, 0.8, 1, 1.5, or even 2 wt % and less than 2.5, 3, 4, 5, 6, 7, 8, 9, or even 10 wt % of an ionic liquid that does not polymerize with the (meth)acrylate matrix of the composite adhesive.

The choice of the ionic liquid used in the composite adhesive can impact electr-debonding. For example, it may be advantageous to choose ionic liquids that have a high conductivity or ionic mobility. While not being limited by theory, it is believed that increased ionic liquid mobility in the adhesive is beneficial for electro-debonding. As such, it may be beneficial for the ionic liquid to be highly soluble in the adhesive matrix (i.e., the ionic liquid does not phase separate from the adhesive matrix). High mobility and high conductivity (e.g., having sheet resistance less than 1×10³ ohms per square) of the ionic liquid in the adhesive matrix could help enable electro-debonding in thicker adhesives. In some embodiments the adhesive thickness could be 10, 25, 50, 60, 70, 80, 90, 100, 150, 200, 250, 300, 400, or even up to 500 microns thick. Alternatively, or additionally, it may be advantageous to choose ionic liquids that have electrochemically unstable cations or anions. While not wanting to be limited by theory, it is believed that more electrochemically unstable cations or anions could produce an increased electro-debonding response. As such, it may be beneficial to choose cations comprised of imidazolium or pyridinium derivatives over quaternary ammonium derivatives.

In one embodiment, it may be beneficial for environmental reasons to choose ionic liquids that do not contain carbon-fluorine bonds. As such, it may be beneficial to choose ionic liquids containing inorganic fluorine such as the hexafluorophosphate or tetrafluoroborate ion in lieu of organic fluorine such as bis(trifluoromethylsulfonyl)imide.

In one embodiment, the composite adhesive disclosed herein is not a foam, meaning that the (meth)acrylate-based matrix comprises less than 5% by volume of voids, where the voids may be obtained by cells formed by gas, or due to the incorporation of hollow fillers, such as hollow polymeric particles, hollow glass microspheres, or hollow ceramic microspheres.

The composite adhesives disclosed herein may advantageously be used to prepare a wide range of adhesive tapes and articles. Many of these tapes and articles contain backings or release liners used to support the layer of adhesive. As used herein a backing is a permanent support intended for final use of the adhesive article. A liner, on the other hand, is a temporary support that is not intended for final use of the adhesive article and is used during the manufacture or storage to support and/or protect the adhesive article. A liner is removed from the adhesive article prior to final use. To facilitate easy removal from the adhesive layer, the liner is typically coated with a release coating comprising a release agent. Such release agents are known in the art and are described, for example in “Handbook of Pressure Sensitive Adhesive Technology,” D. Satas, editor, Van Nostrand Reinhold, New York, N.Y., 1989, pp. 585-600. In one embodiment, the release agent migrates to the surface (on the liner or release coating) to provide the appropriate release properties. Examples of release agents include carbamates, silicones and fluorocarbons. Illustrative examples of surface applied (i.e., topical) release agents include polyvinyl carbamates such as disclosed in U.S. Pat. No. 2,532,011 (Dahlquist et al.), reactive silicones, fluorochemical polymers, epoxysilicones such as are disclosed in U.S. Pat. No. 4,313,988 (Bany et al.) and U.S. Pat. No. 4,482,687 (Kessel et al.), polyorganosiloxane-polyurea block copolymers such as are disclosed in EP Pat. No. 0250248 B1 (Leir et al.), etc.

In one embodiment, the adhesive article is a double-sided tape, featuring adhesive on opposite sides of a carrier layer. The adhesives (i.e., a first adhesive layer and a second adhesive layer) on the two sides may be the same or different. The carrier layer may be a film, a non-woven web, paper, or a foam as further described below. The double-sided tape may comprise one or two release liners protecting the adhesive surface not in contact with the carrier layer. The carrier film may be a flexible or inflexible backing material, or a release liner. Exemplary materials useful as the carrier film for the adhesive articles of the disclosure include, but are not limited to, polyolefins such as polyethylene, polypropylene (including isotactic polypropylene and high impact polypropylene), polystyrene, polyester, including poly(ethylene terephthalate), polyvinyl chloride, poly(butylene terephthalate), poly(caprolactam), polyvinyl alcohol, polyurethane, poly(vinylidene fluoride), cellulose and cellulose derivatives, such as cellulose acetate and cellophane, and wovens and nonwovens. Commercially available carrier film include kraft paper (available from Monadnock Paper, Inc.); spun-bond poly(ethylene) and poly(propylene), such as those available under the trade designations “TYVEK” and “TYPAR” (available from The Chemours Co.); and porous films obtained from poly(ethylene) and poly(propylene), such as those available under the trade designations “TESLIN” (available from PPG Industries, Inc.), and “CELLGUARD” (available from Hoechst-Celanese). The carrier film delivers the pressure sensitive adhesive of the present disclosure to the desired substrate. The carrier film may comprise on the surface opposite the composite adhesive, a pigment, indicia, text, design, etc., which is then fixedly attached to the surface of the substrate or the carrier film may be free of such pigments and/or markings.

In one embodiment, the adhesive layer is disposed between two release liners, which may be the same or different. In another embodiment, the adhesive layer is disposed on a backing and the opposing side of the backing comprises a release agent. The adhesive article is wound upon itself such that the exposed surface of the adhesive layer (opposite the backing) contacts the release-coated backing forming, for example, a roll of tape. In yet another embodiment, the adhesive is disposed between a backing and release liner. In some embodiments, the adhesive tapes and articles do not contain a backing and therefore are free standing adhesive layers. Transfer adhesive tapes are an example of such an adhesive article. Transfer adhesives tapes, also called transfer tapes, have an adhesive layer delivered on one or more release liners. The adhesive layer has no backing within it so once delivered to the target substrate and the liner is removed, there is only adhesive. Some transfer tapes are multi-layer transfer tapes with at least two adhesive layers that may be the same or different. Transfer tapes are widely used in the printing and paper making industries for making flying splices, as well as being used for a variety of bonding, mounting, and matting applications both by industry and by consumers.

In one embodiment, the composite adhesive compositions may be easily coated upon a carrier or backing to produce adhesive coated sheet materials cured via ultraviolet radiation. Coating techniques known in the art may be used such as spray coating, flood coating, knife coating, Meyer bar coating, gravure coating, and double roll coating. The coating thickness will vary depending upon various factors such as, for example, the particular application or the coating formulation. Coating thicknesses of at least 10, 20, 25, 30, 40, 50, 60, 75, or even 100 μm (micrometers) and at most 125, 150, 200, 250, 300, or even 500 μm are contemplated.

In some embodiments, the thickness of the composite adhesive layer is no thicker than 100, 150, or even or even 200 microns and at most 300, 500, 1000, 1500, or even 2000 microns (80 mils). The adhesive can be coated in single or multiple layers. The thickness of the adhesive layer should be at least as thick, preferably thicker than the average particle diameter of the polymeric microspheres contained therein. In some embodiments, having a thicker adhesive layer may be preferable, for example, for better impact resistance performance. However, a thicker adhesive may be more challenging to electrically debond due to its more insulating character.

In one embodiment, the composite adhesive of the present disclosure comprises at least 0.5, 1, 2, 4, 5, or even 10 grams of the plurality of polymeric microspheres per 100 grams of the (meth)acrylate-based matrix. In one embodiment, the composite adhesive composition comprises at most 10, 15, 20, 25, 30, or even 35 grams of the plurality of polymeric microspheres per 100 grams of the (meth)acrylate-based matrix. Typically, the addition of the polymeric microspheres is thought to increase the shear and tensile modulus of the resulting composition. Thus, for (meth)acrylate-based matrices that have lower modulus, more polymeric microspheres can be used to achieve improved shear resistance in either slow or fast applications of stress.

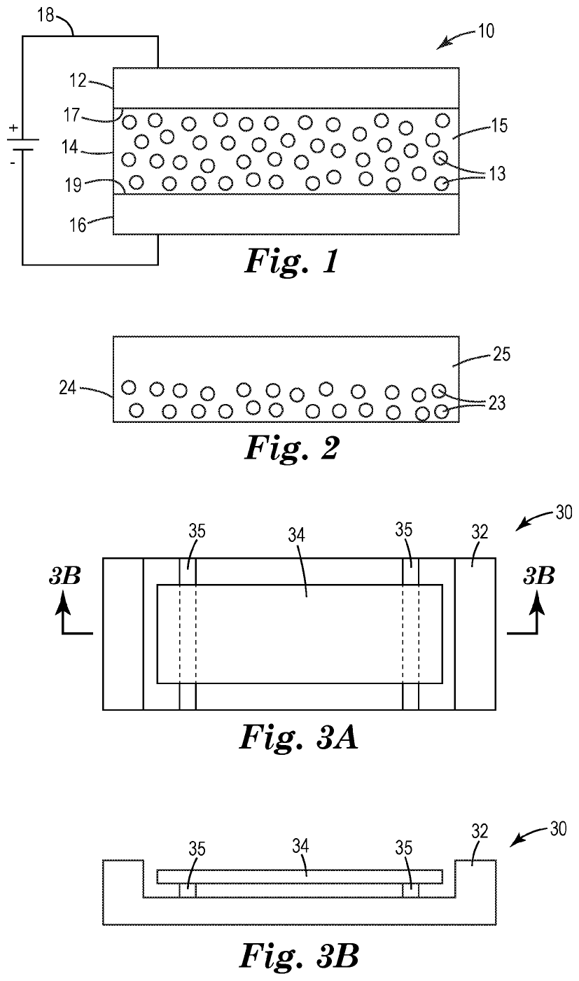

Typically, the polymeric microspheres are homogeneously dispersed throughout the (meth)acrylate-based matrix in layer of the adhesive as shown in FIG. 1. FIG. 1 depicts a multilayered adhesive article 10 comprising optional first substrate 12, and second substrate 16, which may be independently an adherend, a liner, or a backing. Sandwiched therebetween is a layer of the composite adhesive composition 14 comprising a plurality of polymeric microspheres 13 dispersed in (meth)acrylate-based matrix 15. Alternatively, the polymeric microspheres may be concentrated in one or more regions of a layer of the pressure sensitive adhesive. For example, as shown in FIG. 2, the plurality of polymeric microspheres 23 in (meth)acrylate-based matrix 25 are concentrated near one major surface of composite adhesive layer 24.

In one embodiment, the composite adhesive compositions of the present disclosure are a pressure sensitive adhesive. Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength. Materials that have been found to function well as pressure sensitive adhesives are polymers designed and formulated to exhibit the requisite viscoelastic properties resulting in a desired balance of tack, peel adhesion, and shear holding power.

In one embodiment, the pressure sensitive adhesive composition has a viscoelastic window as defined by E. P. Chang, J. Adhesion, vol. 34, pp. 189-200 (1991) such that the dynamic mechanical properties of the pressure sensitive adhesive composition as measured by well-known techniques fall within the following ranges measured at 25° C.:
G′ measured at an angular frequency of 0.01 rad/s is greater than 1×10³ Pa;
G′ measured at an angular frequency of 100 rad/s is less than 1×10⁶ Pa;
G″ measured at an angular frequency of 0.01 rad/s is greater than 1×10³ Pa; and
G″ measured at an angular frequency of 100 rad/s is less than 1×10⁶ Pa.

In one embodiment, the composite adhesive compositions of the present disclosure are heat-activated film adhesive, wherein a film, upon heating becomes tacky (i.e., Dahlquist criterion for tack has a shear storage modulus of less than 0.3 MPa at an angular frequency of 1 Hz.

The present disclosure has identified that a composite comprising a plurality of functionalized particles dispersed within a (meth)acrylate-based matrix results in an adhesive composition, having good impact resistance in resisting tensile and shear impact forces, as well as good dynamic shear resistance. Typically, the addition of the plurality of particles increases the shear storage modulus (G′) of the resulting composition. It is inferred that the increased shear storage modulus is related to the adhesives' shear resistance to deformation. In other words, the addition of the plurality of polymeric microspheres, makes the composite adhesive more “stiff”. Typically, the addition of the (meth)acrylate macromer in the composition of the present disclosure is thought to decrease the shear storage modulus and Tg of the resulting composition, enabling the resulting composite adhesive to have improved resistance to tensile debonding as demonstrated by improved performance in the Random Free Fall Testing. When a “softer” (meth)acrylate resin (i.e., a resin with a shear storage modulus below 80, or even 60 kPa) is used, the addition of the plurality of polymeric microspheres increases the shear storage modulus, however, the Random Free Fall testing suffers. Thus, addition of the (meth)acrylate macromer helps to balance the resistance to tensile debonding enabling these softer resins to resist both tensile impact forces and resistance to shear deformation.

In one embodiment, the composite adhesives disclosed herein have a peak stress in dynamic shear testing of at least 0.4, 0.5, 0.7, 0.8, or even 0.9 MPa; and at most 2.0, 1.8, 1.7, 1.6, 1.5, 1.4, 1.3, 1.2, 1.1, or even 1.0 MPa.

In one embodiment, the composite adhesives disclosed herein have a shear storage modulus (G′) at 25° C. and 1 Hz of at least 50, 100, 150, 200, 300, or even 400 kPa (kiloPascals).

Generally, due to the composite nature of the adhesive composition of the present disclosure, two peak tan deltas are observed when tested. In one embodiment, the lowest temperature peak tan delta of the composite adhesives is at least −40, −30, −20, −10, −5, 0, or even 5° C. In one embodiment, the lowest temperature peak tan delta of the composite adhesives is no more than 60, 50, 40, 30, 20, or even 10° C.

In one embodiment, the composite adhesives disclosed herein, when assembled and tested as disclosed in the Random Free Fall Testing are dropped at 1 meter 50 times, the sample did not fail. In yet another embodiment, the composite adhesives disclosed herein, when assembled as tested as disclosed in the Random Free Fall Testing are dropped at 1 meter 100 times, the sample did not fail. In another embodiment, the composite adhesives disclosed herein, when assembled as tested as disclosed in the Random Free Fall Testing are dropped at 1 meter 250 times, the sample did not fail.

In one embodiment, the composite adhesives according to the present disclosure not only have good adhesion to substrates having a high surface energy, but also demonstrate good adhesion to low surface energy substrates. In one embodiment, the pressure sensitive adhesive of the present disclosure has a peel value greater than or equal to 0.4, 0.5, 0.6, or even 0.8 N/mm when tested according to ASTM D 3330/D3330M on a stainless steel substrate with an adhesive thickness of 8 mils (200 micrometers) when laminated and peeled at room temperature. The peel strength may be adjusted based on the required application, with some applications requiring a higher peel strength (for example from at least 0.5, 0.6, 0.7, or even 0.8 N/mm and at most 2.5, 2.2, 2.1, or even 2.0 N/mm).

In one embodiment, the composite adhesives disclosed herein are optically clear. In one embodiment, the difference between the refractive index of the plurality of polymeric microspheres and the refractive index of the (meth)acrylate-based matrix is less than 0.2, 0.1, or even 0.05. The refractive index can be determined by using techniques known in the art. For example, the Becke Line Method wherein certified refractive test liquids are used along with a microscope to determine the refractive index of a material or the refractive index may be determined by using a refractometer and measuring the bend of a wavelength of 589 nm (sodium D line) at 25° C. in air.

In one embodiment, the composite adhesives disclosed herein comprising an ionic liquid can undergo electrically induced adhesive debonding, wherein the composite adhesive can be debonded on demand with the application of a voltage across the adherend substrates. Although not wanting to be limited by theory, it is believed that when a voltage is applied to the composite adhesive comprising an ionic liquid, the cations migrate toward the cathode side and the anions migrate toward the anode side and electrolysis of the ionic liquid occurs, thereby weakening the adhesive interface. Typically to perform the electro-debonding, the composite adhesive comprising the ionic liquid should be positioned between two electrically conductive surfaces. For example, in one embodiment, both first substrate 12 and second substrate 16 in FIG. 1 comprises an electrically conductive material to form an anode and a cathode, respectively, to conduct the electro-debonding. As shown in FIG. 1, electrical potential 18 is applied across multilayered article 10 having a first electrically conductive surface 17 and a second electrically conductive surface 19. The composite adhesive composition 14 in FIG. 1 joins the first substrate 12 and second substrate 16 together. The first electrically conductive surface 17 serves as the positive adhesive interface and the second electrically conductive surface 19 serves as the negative adhesive interface. Application of a DC (direct current) electrical potential across the composite adhesive composition 14 results in a weakening of the adhesive bond, for example, at the negative adhesive interface (i.e., second electrically conductive surface 19), as measured, for example, according to the work of adhesion per surface area, thus making it easier to separate the second substrate 16 from the first substrate 12. If it is desirable that the adhesive composition remain predominately on the second substrate, the polarity of the DC electric potential can be reversed so that the first electrically conducting surface serves as the negative adhesive interface.

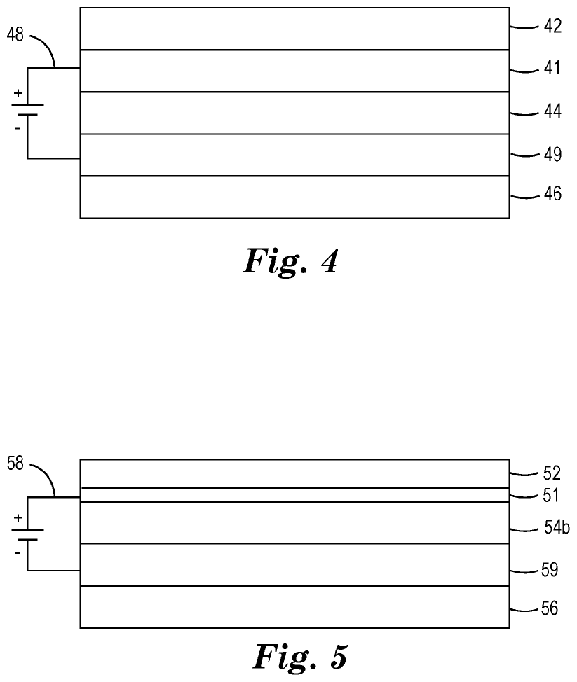

If the adherend substrate is not electrically conductive or has low electrical conductivity (for example, having a sheet resistance of at least 1×10³ or even 5×10³ ohms per square), then another layer, such as a conducting coating should be used to enable the electrical debonding. Such a schematic is shown in FIG. 4, where composite adhesive layer 44 is disposed between first substrate 42 and second substrate 46, which are both electrically non-conducting. First electrically conductive layer 41 is positioned between first substrate 42 and composite adhesive layer 44 while second electrically conductive layer 49 is positioned between second substrate 46 and composite adhesive layer 44. The first electrically conductive layer and the second electrically conductive layer, may or may not be the same material. The electrically conductive layer could be a coating or a layer. Application of electrical potential 48 is then applied between first electrically conductive layer 41 and second electrically conductive layer 49 to weaken the adhesive bond enabling separation of second substrate 46 from first substrate 42. Although an electrically conductive layer is shown, for purposes of this disclosure, it is only necessary that the surface of the substrate in direct contact with the composite adhesive composition be sufficiently coated with an electrically conductive material to weaken the adhesive bond at the negative adhesive interface when a DC electric potential is applied across the composite adhesive composition. In some embodiments, the electrically conductive layer (or coating) is a continuous layer. In other embodiments, the electrically conductive layer (or coating) is pattern coated onto the surface of the substrate. In yet another embodiment, the electrically conductive layer is disposed within the composite adhesive layer as shown in FIG. 5. For example, in FIG. 5, first electrically conductive layer 51 is positioned between the composite adhesive layers 54a and 54b, while second electrically conductive layer 59 is positioned opposite composite adhesive layer 54b. Application of electrical potential 58 is then applied between first electrically conductive layer 51 and second electrically conductive layer 59 to weaken the adhesive bond enabling separation of second substrate 56 from first substrate 52.

To perform debonding on demand, the electrically-conductive surfaces (e.g., first electrically conductive layer 41 and second electrically conductive layer 49) are electrically coupled to or in electrical communication with a power source in a closeable electrical circuit. The power source may be a direct current power supply that provides a DC voltage in the range of about 3V to 250V, although other variations are contemplated. The amount of voltage applied can also be dictated by the amount of time (for example 0.1, or 1 to 5 minutes) the voltage is applied. For example, a higher voltage may be applied for a short amount of time. Electrical potential is applied between the two opposing electrically conductive surfaces (e.g., first electrically conductive layer 41 and second electrically conductive layer 49) in order to de-bond composite adhesive 44 from one or both of the electrically conductive surfaces, enabling the separation of first substrate 42 and second substrate 46. For example, while not intending to be hound by any particular theory, it is believed that a movement of ions within the composite adhesive may be affected by application of the electrical potential thereto. Upon a sufficient amount of movement being affected, e.g., sufficient ionic components appear adjacent to the electro-conductive surface, the adhesive qualities of the adhesive material is reduced, enabling separation of the electro-conductive surfaces and/or composite adhesive.

Exemplary conductive materials which can be used in the conducting layer or coating include, an electrically conductive carbonaceous material or an electrically conductive metal. The electrically conductive surface may comprise a conventional material such as a metal, mixed metal, alloy, metal oxide, and/or composite metal oxide, or it may include a conductive polymer. Examples of suitable metals for the electrically conductive layer include the Group 1 metals, the metals in Groups 4, 5, and 6, and the Group 8-10 transition metals. Further examples of suitable metals for the electrically conductive layer include stainless steel. Al, Ag, Mg, Ca, Cu, Mg/Ag, LiF/Al, CsF, and/or CsF/Al and/or alloys thereof.

The composite adhesive compositions described herein are suitable for use in the areas of electronics, appliances, automotive, and general industrial products. In some embodiments, the adhesive can be utilized in (e.g. illuminated) displays that can be incorporated into household appliances, automobiles (e.g., adhering to panels), computers (e.g. tablets), or various hand-held devices (e.g. phones).

In some embodiments, the composite adhesive compositions described herein are suitable for bonding internal components or external components of illuminated display devices such as liquid crystal displays (“LCDs”) and light emitting diode (“LEDs”) displays such as cell phones (including Smart phones), wearable (e.g. wrist) devices, car navigation systems, global positioning systems, depth finders, computer monitors, notebook, or tablet computer displays or bonding items (e.g., handles, display holders) to the exterior of electronic devices.

### Examples

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

All materials are commercially available, for example from Sigma-Aldrich Chemical Company; or known to those skilled in the art unless otherwise stated or apparent.

These abbreviations are used in the following examples: ° C.=degree Celsius, cP=CentiPoise, g=gram, lb=pound, kg=kilograms, mL=milliliter, mol=mole, m=minutes, cm=centimeter, Hz=Hertz, J=Joule, kDa=kiloDalton, l=liter, mm=millimeter, mW=milliWatt, N=Newton, nm=nanometer, Pa=Pascal, rpm=revolutions per minute, ppm=parts per million, and wt=weight.

TABLE 1
Materials Used in Examples

| Abbreviation | Description and Source |
|---|---|
| 2-EHA | 2-Ethylhexyl acrylate, obtained from BASF, Ludwigshafen, Germany |
| IBOA | Isobornyl acrylate, obtained from San Esters, New York, NY |
| AA | Acrylic acid, obtained from BASF, Ludwigshafen, Germany |
| NNDMA | N, N-dimethylacrylamide, obtained from TCI America, Portland, OR |
| HDDA | 1,6-Hexanediol diacrylate, obtained from Arkema, Paris, France |
| 2-MBA | 2-Methylbutyl acrylate, can be obtained from Monomer Polymer & |
| | Dajac Labs, Ambler, PA |
| nBA | n-butyl acrylate, obtained from TCI America, Portland OR |
| toACM | Tert-octylacrylamide, obtained from Nouryon, Amsterdam, Netherlands |
| MPEG-A | Poly(ethylene glycol)-methyl ether acrylate, Mn = 550 Da obtained from |
| | Sans Esters, Osaka, Japan |
| HBA | 4-hydroxybutyl acrylate, obtained from BASF, Ludwigshafen, Germany |
| PTHF-VDM | Adduct of poly(tetramethylene glycol) monomethyl ether and 2-vinyl- |
| | 4,4-dimethylazlactone, Mn = 3.1 kDa, synthesized herein |
| PTHF-A | Poly(tetrahydrofuran)-methyl ether acrylate, Mn = 2 kDa, prepared as in |
| | WO2022/043784 A1 (Schneiderman et al.), synthetic route 1. |
| MAA | Methacrylic acid, obtained from Alfa Aesar, Haverhill, MA |
| NVP | 1-vinyl-1-pyrollidone, obtained from TCI America, Portland, OR |
| 1150 | 4-tert-butylcyclohexyl acrylate, obtained under the trade designation |
| | “MIRAMER M1150” from Miwon Specialty Chemical Co., Columbia, |
| | SC |
| C12 Acrylate | A blend of C12 acrylates, primarily 2-dodecylacrylate, as described in |
| Blend | U.S., Pat. No. 9102774B2 (Clapper et al.). |
| STEPANOL | Ammonium lauryl sulfate, obtained under the trade designation |
| AMV | “STEPANOL AMV” from Stepan, Northfield, IL |
| HITENOL | Polyoxyethylene alkylphenyl ether ammonium sulfate, obtained under |
| BC-1025 | the trade designation “HITENOL BC-1025” from Montello, Tulsa, OK |
| SUPERFLOC | Polyacrylamide, obtained under the trade designation “SUPERFLOC |
| N300 | N300” from Kemira, Atlanta, GA |
| VAZO 52 | 2,2′-azobis(2,4-dimethylvaleronitrile), obtained under the trade |
| | designation “VAZO 52” from Chemours, Wilmington, DE |
| VAZO 67 | 2,2′-azobis(2-methylpropionitrile), obtained under the trade designation |
| | “VAZO 67” from Chemours, Wilmington, DE |
| VAZO 88 | 1,1′-azobis(cyclohexanecarbonitrile), obtained under the trade |
| | designation “VAZO 88” from Chemours, Wilmington, DE |
| IRG 651 | 2,2-dimethoxy-2-phenylacetophenone, obtained under the trade |
| | designation “IRGACURE 651”, obtained from Ciba Specialty |
| | Chemicals, Basel, Switzerland |
| EMS | Low-density, polymeric microspheres coated with calcium carbonate, |
| | obtained under the trade designation “DUALITE E135-040D” from |
| | Chase Corporation, Westwood, MA |
| DBU | 1,8-diazabicyclo[5.4.0]undec-7-ene, can be obtained from Millipore |
| | Sigma, Burlington, MA |
| VDM | 2-vinyl-4,4-dimethylazlactone, which can be synthesized using methods |
| | as disclosed in U.S. Pat. No. 4,639,286 (Rasmussen et al.) |
| PC-CB | Carbon black dispersion with ca. 30% carbon black, obtained from Penn |
| | Color, Doylestown, PA available under the product number 9B2558. |
| BMI TFSI | 1-butyl-3-methylimidazolium bis(trifluoromethanesulfonyl)imide, |
| | obtained from Sigma Aldrich, St. Louis, MO |
| BMI PF6 | 1-butyl-3-methylimidazolium hexafluorophosphate, obtained from TCI |
| | America, Portland, OR |
| BMI I | 1-butyl-3-methylimidazolium iodide, obtained from Sigma Aldrich, St. |
| | Louis, MO |
| FC-5000 | Antistatic ionic liquid additive, obtained from 3M, St. Paul, MN |
| TES TFSI | Triethylsulfonium bis(trifluoromethylsulfonyl)imide, obtained from TCI |
| | America, Portland, OR |
| EP TFSI | Ethyl pyridinium bis(trifluoromethanesulfonyl)imide, synthesized as in |
| | Lamanna et al., US6372829B1 |
| TMAEA TFSI | Trimethylammonium ethyl acrylate bis(trifluoromethanesulfonyl)imide, |
| | synthesized as in U.S. Pat. No. 11,111,392 B2 (Klun et al.) |
| RF02N | Silicone coated polyester release liner, 2 mil (51 micrometers) thick, |
| | available under the trade designation “RF02N” from SKC Haas Display |
| | Films LLC, Seoul KR |
| RF12N | Silicone coated PET release liner, 2 mil |
| | (51 micrometers) thick, available under the trade designation |
| | “RF02N” from SKC Haas Display Films |
| | LLC, Seoul KR, wherein the RF02N has a lower release force |
| | (i.e., easier to remove) than the RF12N. |

### Test Methods

### Particle Size Analysis

Microsphere particle-size measurements were performed using a Horiba LA 910 particle size analyzer (Horiba, Ltd, Kyoto, Japan). The particle sizes are reported in micrometers±the standard deviation.

### Rheology and Glass Transition Temperature

Both the RF02N and RF12N liners were removed from the transfer tape samples and the composite adhesive was tested on a TA Instruments discovery hybrid rheometer III (DHR-3), (New Castle, DE). The sample was heated from room temperature up to 40° C. at a rate of 3° C./min then cooled to −50° C. at a rate of 3° C./min, warming up to 20° C. and then heating the sample from 20° C. to 140° C. at a rate of 3° C./min. The data was collected during the second heating cycle at oscillatory frequencies of 1 Hz with strain values in the linear viscoelastic regime (typically 1 to 5%). The glass transition temperature (at 1 Hz) was determined as the peak of the tan(S) curve from the rheology plot of G′ and G″ (y axis −1) vs. temperature (° C.), (x axis) and tan(δ) (y axis-2). The peak (i.e. highest value) in tan(δ) was selected from y axis-2, and the corresponding temperature on the x axis was selected as the glass transition temperature. Tan(δ) is an abbreviation for the tangent of the phase angle between the stress and strain oscillation waves in the shear rheology oscillation plot. Samples that passed the rheology requirements had a shear storage modulus (G′) of >100 kPa at 25° C.

### Number Average Molecular Weight by ¹H-NMR

Nuclear Magnetic Resonance Spectroscopy was performed on a Bruker 500 MHz instrument, Billerica, MA. ¹H-NMR was in CDCl₃ (residual solvent referenced to 7.26 ppm).

### Size Exclusion Chromatography (SEC)

The molecular weight (both number average, Mn, and weight average, M_{w}) and polydispersity were determined using size exclusion chromatography with polystyrene standards. The chromatography system included an instrument available under the trade designation “ACQUITY” (Waters Corporation, Milford, MA) and the following columns in order (going downstream): Styragel guard column (20 μm, 4.6 mm×30 mm) and a first Styragel HR 5E column (mixed bed, 5 μm, 7.8 mm×300 mm, 2K-4M) and a second Styragel HR 5E column (all columns are available from Waters Corporation). Analysis was done using a THF mobile phase at flow rate of 1 mL/min.

### Peel Adhesion Testing

For all peel adhesion testing, the RF02N release liner was removed from the transfer tape sample, and the exposed adhesive side of the transfer tape was contacted to the plasma treated side of a 6 inch (15 cm) wide plasma treated polyester film (3M Co., 2-mil (50-μm) biaxially oriented PET film whose surface had undergone plasma treatment conditions described in U.S. Pat. No. 10,134,566 (David et al.)). Then, a 6 inch (15 cm) rubberized hand roller (Polymag Tek, NY) was rolled by hand over the construction ensuring no air bubbles were trapped between the adhesive and the primed polyester film. Peel adhesion was measured at an angle of 180 degrees. Peel adhesion testing was performed on annealed 18 gauge, 304 stainless steel (SS) test panel from Chem. Instruments, Fairfield, OH). The RF12N release liner was removed from the tapes on PET backings and the exposed adhesive side was laminated directly to the 2-inch×6-inch (5.08 cm×15.24 cm) stainless steel test panel using a weighted rubberized (4.5 lb, 2.04 kg) hand roller with 4 repetitions of 3 second roll downs. The transfer tape, stainless steel test panel, and the transfer tape applied to the stainless steel test panel were conditioned in a controlled temperature and humidity (CTH) room (set at 23° C., 50% RH (relative humidity)) prior to peel testing. SS test panels were cleaned with methyl ethyl ketone (MEK) before and after testing. Peel testing was done using an SP-2100 iMass (iMass Inc., Accord, MA USA) at a rate of 12 inches/min (0.3 m/min). Each sample was peeled at least three times from the same substrate and averages of all three measurements are reported. The peel adhesion force and the failure mode were recorded. All of the samples exhibited adhesive failure (i.e., break between the adhesive and the SS panel), except for the sample marked, which broke between the adhesive and the polyester film.

### Dynamic Shear Testing

For dynamic shear testing, a modified version of ‘ASTM D1002-2019—Apparent Shear Strength of Single-Lap-Joint Adhesively Bonded Metal Specimen’ was used. Shear of the adhesive was tested between the ends of two overlapped 304 stainless steel (SS) panels (1 inch (2.5 cm) wide×4 inches (10.1 cm) long× 1/16 inch (1.6 mm) thick), with an overlap adhesive bonded region of 1 inch (2.5 cm)) by 1 inch (2.5 cm)). To prepare the test specimens, 1 inch (2.5 cm) by 1 inch (2.5 cm) square sample of the designated transfer tapes were cut and the RF02N liner was removed and the exposed adhesive side of the transfer tape was laminated at room temperature to the end of one of the SS panels. Then the RF12N liner was removed from the transfer tape bonded to the first SS panel, and the exposed adhesive was bonded to the second SS panel ensuring an overlap area of 1 inch (2.5 cm) by 1 inch (2.5 cm)). The bonded laminate was then weighed down with a 50 lb (22.7 kg) weight applied over the 1 inch (2.5 cm) by 1 inch (2.5 cm) adhesive bonded area at room temperature for 30 s and allowed to dwell at room temperature for a minimum of 1 day. The adhesive joint was tested after dwell time by gripping the opposite ends of the stainless steel substrates within a load frame (MTS, Eden Prairie, MN) and tested at a rate of displacement of 10 mm/min (vertical crosshead speed). The maximum peak in the stress of the stress-strain curve was used to determine the peak stress of the adhesive specimen in the dynamic shear test.

### Random Free Fall Testing

Random free fall testing was performed on a Heina Tumble Tester II (Heina, Halikko, Finland) with test specimen 30 as shown in FIGS. 3A (top view) and 3B (cross sectional view). As shown in FIG. 3 A, polycarbonate panel 34 is adhered to test buck 32 using two adhesive stripes 35. The adhesive stripes were 2 mm wide. The polycarbonate test buck (available from Chem Instruments, Fairfield, OH, USA) was 6.25 inches (15.8 cm)) long×3.25 inches (8.3 cm) wide×0.375 inches (9.5 mm)) thick at the base. The test buck had a raised portion (about 0.25 inches (0.63 cm) high from the base) along each short side edge which was designed to come in contact with the tumble tester surfaces and to prevent direct contact with the polycarbonate panel and the tumble tester surfaces. The polycarbonate panel was 5.125 inches (13 cm)) long×2.875 inches (73 cm) wide×0.125 inches ((3.2 mm) thick. The test specimens were prepared as follows. The adhesive transfer tape was cut to 3.25 inches (8.3 cm) long×2 mm wide using a 2 mm wide tape slitter. The RF02N release liner was removed from each strip of transfer tape and the exposed adhesive side was laminated to the test buck such that the adhesive was placed 1 inch (2.5 cm)) parallel from each opposite edge of the test buck. Then the RF12N liner was removed from each adhesive strip and the polycarbonate panel was laminated onto the test buck using the adhered adhesive strips, ensuring that the panel was a fixed distance away from each raised portion of the test buck. A 4 kg weight was placed over the length of each adhered strip of the adhesive tape and a third 4 kg weight was placed on top of the two other weights. The weights were dwelled on the tapes for 30 s and then the bonded test specimens placed into a CTH room for 3 days. The bonded test specimens were then placed into the Heina tumble tester and was repeatedly dropped from a height of 1 m at a rate of 12 drops per minute. Drops prior to failure (as indicated by pop off from one or both sides of the polycarbonate panel from the polycarbonate test buck) were counted. Samples were dropped 250 times. A result of 250+ means the sample survived 250 drops.

### Corrosion Test

To prepare the test specimens, a 1 inch (2.5 cm) by 1 inch (2.5 cm) square sample of the designated transfer tapes were cut and the RF02N liner was removed and the exposed adhesive side of the transfer tape was laminated at room temperature to a 2 mil (50 micrometers)—thick biaxially oriented polyethylene terephthalate (PET) film. Then the RF12N liner was removed from the transfer tape bonded to the PET panel, and the exposed adhesive was hand rolled down to a copper foil sheet. The test specimens were placed in an oven set at 65° C. and at 90% relative humidity (RH). The specimens were removed from the oven on Day 1 and Day 3 and evaluated for signs of corrosion (discoloration of the copper foil). The specimens were then scored on a scale 1-3 where 1=no sign of corrosion, 2=less than or equal to 25% of the copper foil area has corrosion and 3=more than 25% of the copper foil area has visible corrosion.

### Electro-Debonding Test

A tensile pushout setup was used comprising a stainless steel coupon (40 mm×40 mm×3 mm) containing a circular hole (diameter=24 mm) in the center and a circular stainless steel puck (diameter=33 mm, 3 mm thick). The designated transfer tapes were die cut into a ring having an outer diameter of 31 mm and an inner diameter of 26 mm. The RF02N liner was removed and the exposed adhesive side of the transfer tape ring was laminated around the circular hole on the stainless steel coupon. Then the RF12N liner was removed from the transfer tape bonded to the coupon and the exposed adhesive was bonded to the stainless steel puck such that the puck covered the hole in the coupon. The test specimens were weighed down with an 8 kg weight for 30 seconds at 23° C. and then removed. The test specimens then were dwelled at 23° C./50% RH for at least 2 days before testing. Then, a power source (1685B series available from B&K Precision, Yorba Linda, CA) was connected to the pushout setup, with the positive electrode connected to puck and the negative electrode connect to the coupon. A voltage of 50 volts was applied across the coupon and puck for 180 seconds unless otherwise indicated. Immediately following the 180 seconds of applied voltage, the electrodes were disconnected from the test specimen and the test specimen was loaded onto an electromechanical tester (MITS Criterion Model C43, Eden Prairie, MN). The stainless steel coupon was held in place while a 0.75 inch (19 millimeter)-diameter rod from the electromechanical tester was positioned through the circular hole of the stainless steel coupon, contacting the circular stainless steel puck. The electromechanical tester was used to push the puck away from the coupon at a rate of 10 mm/min under ambient conditions. The peak stress required to remove the puck from the coupon was recorded in MPa (mega Pascals). Test specimens where no voltage was applied were also tested in this way. Reported in Table 15 is the Initial push out peak stress (i.e., when no voltage was applied prior to testing) and the % reduction in the push out peak stress after applying 50 volts across the test specimen for 3 minutes (or 180 seconds).

### Preparatory Examples

### Synthesis of PTHF-VDM

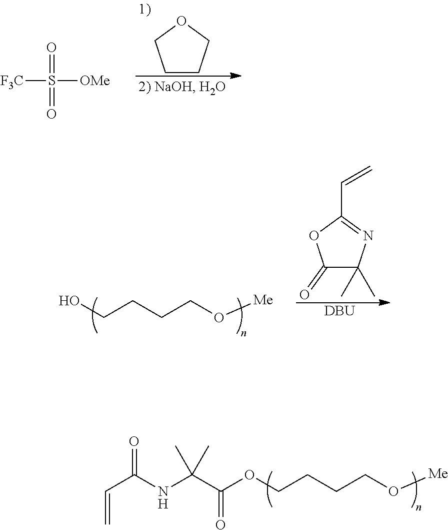

A flame dried Schlenk flask was equipped with a polytetrafluoroethylene-coated magnetic stirrer and charged with 563 g of dry tetrahydrofuran (THF) under a nitrogen atmosphere. Then, 5.0 mL of freshly distilled methyl trifluoromethanesulfonate was added to the reactor. After 18 minutes, the reaction was quenched with 100 mL of 2 wt. % aqueous sodium hydroxide. The excess THF was removed by rotary evaporation. Approximately 300 mL of dichloromethane (DCM) was added to dissolve the polymer. A phase separation resulted and the organic phase was retained and washed with deionized water (4 times with 300 mL aliquots). The washed organic phase was dried over magnesium sulfate and filtered. Any volatile solvent in the organic phase was removed by rotary evaporation to yield PTHF-OH.

A dried round bottom flask was equipped with stir bar and reflux condenser and was charged with 50 g of PTHF-OH (Mn=3100 Da, 16 mmol —OH end group), 0.5 mL DBU (3.3 mmol, 0.2 eq), 240 mL of dry DCM, and 2.6 mL of VDM (2.704 g, 19.4 mmol, 1.2 eq). The reaction was refluxed for 16 hours. After cooling, the solution was transferred to a separatory funnel and was washed with 0.2 N KOH (3 times with 80 mL aliquots) followed by deionized water (2 times 80 mL aliquots). The desired organic layer was dried over magnesium sulfate and any volatile solvent was removed via rotary evaporation to yield the product. The final product, PTHF-VDM, had a number average molecular weight of 3.1 kDa as determined by end group analysis in 1H-NMR.

### Representative Microsphere Preparation

An aqueous phase was prepared in a 1000 mL resin flask (4 inch (10 cm) diameter) using deionized water and the surfactants and their weight percentages relative to the total aqueous phase amounts as shown in Table 3. In a separate flask, an oil phase was prepared by mixing the various monomer listed in Table 2, where phr refers to parts by weight added per 100 parts by weight of the IBOA. Then, the specified initiator package as described in Table 4 was added to the oil phase, where the percentages listed in Table 4 where the amounts by wight added per the total weight of monomer from Table 2. Then, the aqueous phase was mixed with the oil phase such that the ratio of the aqueous phase to the oil phase was 50 wt %. An overhead stirrer equipped with a glass trailing edge (3 blade) stir rod was used to mix the phases using the rates (in rpm's) as shown in Table 5. During the agitation, the multi-phase mixture was degassed by sparging with nitrogen for 30 minutes. After degassing, the mixture was heated to 52° C. The peak temperature during the exotherm typically reached as high as 85° C. After peak exotherm, the reaction was heated to 95° C. and was then maintained at that temperature for 3 hours. The mixture was cooled to room temperature. The solid microspheres were filtered in a Buchner funnel onto filter paper, washed with water and dried under vacuum.

TABLE 2
Monomer Package Compositions for Synthesis of Microspheres (wt. % monomers
unless otherwise stated, phr relative to 100 wt. % monomer)

| | | | | C12 | | | | |
|---|---|---|---|---|---|---|---|---|
| Monomer | | | | Acrylate | | | | HDDA |
| Package | IBOA | 1150 | 2-EHA | blend | nBA | MAA | HBA | (phr) |
| MONO1 | 100 | — | — | — | — | — | — | 0.05 |
| MONO2 | 98 | — | — | — | — | 2 | — | 0.05 |
| MONO3 | 95 | — | — | — | — | 5 | — | 0.05 |
| MONO4 | 95 | — | — | — | — | 5 | — | 0.05 |
| MONO5 | 95 | — | — | — | — | 5 | — | 0.05 |
| MONO6 | 95 | — | — | — | — | 5 | — | 0.05 |
| MONO7 | 90 | — | — | — | — | 10 | — | 0.05 |
| MONO8 | 85 | — | 10 | — | — | 5 | — | 0.05 |
| MONO9 | 75 | — | 20 | — | — | 5 | — | 0.05 |
| MONO10 | 90 | — | — | — | — | — | 10 | 0.05 |
| MONO11 | 75 | — | 25 | — | — | — | — | 0.05 |
| MONO12 | — | 95 | — | — | — | 5 | — | 0.05 |
| MONO13 | 75 | — | — | 25 | — | — | — | 0.05 |
| MONO14 | — | — | — | 100 | — | — | — | 0.05 |
| MONO15 | — | — | — | — | 95 | 5 | — | 0.20 |
| MONO16 | 85 | — | 10 | — | — | 5 | — | 0.10 |

TABLE 3
Surfactant Package Compositions (Listed as weight
percentages relative to the aqueous phase)

| Surfactant | STEPANOL | HITENOL | SUPERFLOC |
|---|---|---|---|
| Package | AMV | BC-1025 | N300 |
| U1 | 1 | 1 | 0 |
| U2 | 1 | 1 | 0.07 |
| U3 | 0 | 1 | 0 |

TABLE 4
Initiator Packages Compositions
(Listed relative to 100% monomer weight)

| Initiator | | | |
|---|---|---|---|
| Package | VAZO 52 | VAZO 67 | VAZO 88 |
| I1 | 0.1% | — | — |
| I2 | 0.1% | 0.25% | — |
| I3 | 0.1% | 0.5% | — |
| I4 | 0.1% | — | 0.25% |

TABLE 5
Synthetic Conditions for the Synthesis of Polymeric Microspheres

| Microsphere | | | | | Induction | Cure | Cure |
|---|---|---|---|---|---|---|---|
| Abbreviation | | Monomer | Surfactant | Initiator | Temp. | Temp. | Time |
| (MSA) | rpm | Package | Package | Package | (° C.) | (° C.) | (hr) |
| M1 | 1000 | MONO1 | U1 | I1 | 60 | 60 | 8 |
| M2 | 1000 | MONO2 | U1 | I1 | 60 | 60 | 8 |
| M3 | HSM* | MONO3 | U1 | I1 | 60 | 60 | 8 |
| M4 | 1000 | MONO4 | U1 | I1 | 60 | 60 | 8 |
| M5 | 600 | MONO5 | U2 | I2 | 52 | 95 | 3 |
| M6 | 400 | MONO6 | U3 | I1 | 60 | 60 | 8 |
| M7 | 1000 | MONO7 | U2 | I1 | 60 | 60 | 8 |
| M8 | 600 | MONO8 | U2 | I3 | 52 | 95 | 3 |
| M9 | 600 | MONO9 | U2 | I3 | 52 | 95 | 3 |
| M10 | 600 | MONO10 | U2 | I3 | 52 | 95 | 3 |
| M11 | 1000 | MONO11 | U1 | I1 | 60 | 60 | 8 |
| M12 | 600 | MONO12 | U2 | I3 | 52 | 95 | 3 |
| M13 | 1000 | MONO13 | U1 | I1 | 60 | 60 | 8 |
| M14 | 1000 | MONO14 | U1 | I1 | 60 | 60 | 8 |
| M15 | 400 | MONO15 | U1 | I1 | 60 | 60 | 8 |
| M16 | 375 | MONO16 | U2 | I4 | 52 | 95 | 3 |

*HSM = 40,000 rpm for 2 minutes using a PRO Scientific PRO250 homogenizer (PRO Scientific, Oxford, CT) for 2 minutes and then stirred at 350 rpm with a glass stir rod.

TABLE 6
Microsphere Particle Size

| | Particle Size |
|---|---|
| MSA | (micrometer) |
| M1 | 29 ± 10 |
| M2 | 28 ± 9 |
| M3 | 1.6 ± 0.7 |
| M4 | 25 ± 8 |
| M5 | 47 ± 13 |
| M6 | 151 ± 70 |
| M7 | 22 ± 6 |
| M8 | 46 ± 13 |
| M9 | 47 ± 13 |
| M10 | 51 ± 15 |
| M11 | 29 ± 10 |
| M12 | 41 ± 13 |
| M13 | 32 ± 14 |
| M14 | 32 ± 13 |
| M15 | 75 ± 33 |
| M16 | 38 ± 19 |

Syrups SRP-1 to SRP-7 were synthesized by adding the monomers (as specified in Table 7) together at the appropriate wt % loadings, adding IRG 651 (0.02 phr with respect to total monomers at 100 phr) and exposing the monomer solution to 0.3 mW/cm² UV-LED irradiation (365 nm) until the mixture had a higher viscosity (ca. 1,000 cP). Shown in Table 8 is the molecular weight in megaDaltons (MDa) and the polydispersity of the resulting syrups as determined by the SEC Test Method described above.

MER-1 was prepared by mixing the monomers as specified in Table 9.

TABLE 7
Monomer Compositions Used in Making Syrup Polymers in wt. %

| Syrup | 2-EHA | 2-MBA | IBOA | nBA | NNDMA | toACM | AA | NVP |
|---|---|---|---|---|---|---|---|---|
| SRP-1 | 35 | 35 | — | — | 25 | 5 | — | — |
| SRP-2 | 35 | 35 | 8 | — | 20 | — | 2 | — |
| SRP-3 | 46.5 | 46.5 | — | — | — | 7 | — | — |
| SRP-4 | 90 | — | — | — | — | — | 10 | — |
| SRP-5 | — | — | — | 90 | — | — | 10 | — |
| SRP-6 | — | — | — | 70 | — | — | — | 30 |
| SRP-7 | — | — | — | 80 | — | — | — | 20 |

TABLE 8
Molecular Weight Data of Resulting
Syrup Polymers from Table 7

| | Mₙ | M_{w} | Polydispersity |
|---|---|---|---|
| Syrup | (MDa) | (MDa) | Index |
| SRP-1 | 0.35 | 1.0 | 2.9 |
| SRP-2 | 2.2 | 2.9 | 1.3 |
| SRP-3 | 3.3 | 23.9 | 7 |
| SRP-4 | 0.43 | 1.1 | 2.6 |
| SRP-5 | 0.83 | 1.8 | 2.2 |
| SRP-6 | 0.43 | 0.79 | 1.8 |
| SRP-7 | 0.95 | 1.4 | 1.5 |

TABLE 9
Monomer Composition without Syruping Step

| Monomer | | | | |
|---|---|---|---|---|
| Sample | 2-EHA | 2-MBA | NNDMA | toACM |
| MER-1 | 35 | 35 | 25 | 5 |

### Examples and Comparative Examples

Curable compositions were made using the components as listed in Tables 10 and 11, where phr refers to the weight of the component used versus the weight of the designated Syrup used.

Then each curable composition was coated between two release liners (RF12N and RF02N). The samples then were cured under 405 nm UV-LED lights with a total dosage of 3.1 J/cm² as measured with a radiometer equipped with a high power sensing head (available under the trade designation “POWER PUCK II” from EIT Incorporated, Sterling, VA), resulting in transfer tapes, which had an adhesive layer thickness of 8 mils (200 μm).

TABLE 10
Samples without Ionic Liquids

| | | | PTHF- | | | | | | | | |
|---|---|---|---|---|---|---|---|---|---|---|---|
| | | MPEG- | VDM | MSA | MSA | EMS | AA | NNDMA | PC-CB | HDDA | IRG 651 |
| Sample | Syrup | A (phr) | (phr) | type | (phr) | | | | | | |
| El | SRP-1 | 15 | — | M2 | 15 | — | — | — | — | 0.1 | 0.2 |
| E2 | SRP-1 | 15 | — | M3 | 15 | — | — | — | — | 0.1 | 0.2 |
| E3 | SRP-1 | 15 | — | M4 | 15 | — | — | — | — | 0.1 | 0.2 |
| E4 | SRP-1 | 15 | — | M6 | 15 | — | — | — | — | 0.1 | 0.2 |
| E5 | SRP-1 | 15 | — | M4 + | 10 + 5 | — | — | — | — | 0.1 | 0.2 |
| | | | | M1 | | | | | | | |
| E6 | SRP-1 | 10 | — | M5 | 5 | 1 | — | — | 1.5 | 0.1 | 0.2 |
| E7 | SRP-1 | 10 | — | M5 | 10 | 1 | — | — | 1.5 | 0.1 | 0.2 |
| E8 | SRP-1 | 10 | 20 | M4 | 15 | — | — | — | — | 0.05 | 0.2 |
| E9 | SRP-1 | 15 | — | M5 | 15 | 1 | 1 | — | — | 0.1 | 0.2 |
| E10 | SRP-1 | 10 | — | M8 | 15 | 1 | — | — | 1.5 | 0.1 | 0.2 |
| E11 | SRP-1 | 10 | — | M9 | 15 | 1 | — | — | 1.5 | 0.1 | 0.2 |
| E12 | SRP-1 | 10 | — | M10 | 15 | 1 | — | — | 1.5 | 0.1 | 0.2 |
| E13 | SRP-1 | 10 | — | M5 | 17 | 1 | 1 | — | 1.5 | 0.1 | 0.2 |
| E14 | SRP-2 | 15 | — | M4 | 15 | — | — | — | — | 0.1 | 0.2 |
| E15 | MER-1 | 20 | — | M7 | 15 | — | — | — | — | 0.1 | 0.2 |
| E16 | SRP-1 | 15 | — | M5 + | 5 + 10 | — | — | — | — | 0.1 | 0.2 |
| | | | | M7 | | | | | | | |
| E17 | SRP-1 | 20 | — | M12 | 10 | — | — | — | — | 0.1 | 0.2 |
| E18 | SRP-1 | 15 | — | M12 | 15 | — | — | — | — | 0.1 | 0.2 |
| CE1 | SRP-1 | 20 | — | — | — | — | — | — | — | 0.05 | 0.2 |
| CE2 | SRP-1 | 15 | — | — | — | — | — | — | — | 0.1 | 0.2 |
| CE3 | SRP-1 | 15 | — | M1 | 10 | — | — | — | — | 0.1 | 0.2 |
| CE4 | SRP-1 | 15 | — | M1 | 15 | — | — | — | — | 0.1 | 0.2 |
| CE5 | SRP-3 | 15 | — | M11 | 15 | — | — | 33.5 | — | 0.05 | 0.2 |
| CE6 | SRP-1 | 0 | — | M4 | 10 | — | — | — | — | 0.1 | 0.2 |
| CE7 | SRP-1 | 0 | — | M13 | 5 | — | — | — | — | 0.05 | 0.2 |
| CE8 | SRP-1 | 0 | — | — | — | — | — | — | — | 0.05 | 0.2 |
| CE9 | SRP-1 | 0 | — | M14 | 5 | — | — | — | — | 0.1 | 0.2 |
| CE10 | SRP-1 | 0 | — | M15 | 5 | — | — | — | — | 0.1 | 0.2 |

TABLE 11
Samples with Ionic Liquids

| | | | | | | | Ionic | | IRG |
|---|---|---|---|---|---|---|---|---|---|
| | | MPEG-A | PTHF-A | M16 | EMS | Ionic | Liquid | HDDA | 651 |
| Sample | Syrup | (phr) | (phr) | (phr) | (phr) | Liquid | (phr) | (phr) | (phr) |
| E19 | SRP-1 | 10 | — | 15 | 1 | BMI TFSI | 1 | 0.1 | 0.2 |
| E20 | SRP-1 | 10 | — | 15 | 1 | BMI TFSI | 3 | 0.1 | 0.2 |
| E21 | SRP-1 | 10 | — | 15 | 1 | BMI TFSI | 5 | 0.1 | 0.2 |
| E22 | SRP-1 | — | 10 | 15 | 1 | BMI TFSI | 5 | 0.025 | 0.5 |
| E23 | SRP-1 | 10 | — | 15 | 1 | BMI PF6 | 3 | 0.1 | 0.3 |
| E24 | SRP-6 | 10 | — | 5 | — | FC-5000 | 5 | 0.1 | 0.5 |
| E25 | SRP-6 | 10 | — | 5 | — | TES TFSI | 5 | 0.1 | 0.5 |
| E26 | SRP-6 | 10 | — | 5 | 1 | EP TFSI | 5 | 0.1 | 0.5 |
| E27 | SRP-6 | 10 | — | 5 | 1 | BMI PF6 | 5 | 0.1 | 0.5 |
| E28 | SRP-6 | 10 | — | 5 | 1 | BMI I | 1 | 0.1 | 0.5 |
| E29 | SRP-7 | 10 | — | 5 | 1 | TMAEA TFSI | 20 | 0.1 | 0.5 |
| CE11 | SRP-1 | 10 | — | — | — | BMI TFSI | 5 | 0.1 | 0.2 |
| CE12 | SRP-1 | 10 | — | 15 | 1 | — | — | 0.1 | 0.2 |
| CE13 | SRP-1 | 10 | — | 15 | 1 | BMI TFSI | 0.5 | 0.1 | 0.2 |
| CE14 | SRP-1 | 10 | — | 15 | 1 | BMI TFSI | 10 | 0.1 | 0.2 |
| CE15 | SRP-4 | 5 | — | — | — | BMI TFSI | 5 | 0.1 | 0.2 |
| CE16 | SRP-5 | — | — | — | — | BMI TFSI | 5 | 0.1 | 0.2 |

TABLE 12
Rheological Properties of the Adhesive Compositions

| | Rheology Temperature Ramp | | |
|---|---|---|---|
| | (1 Hz, 3° C./min, <5% strain) | | |
| | | G′ 25° C. | G′ 85° C. |
| Sample | T_{g} (° C.) | (kPa) | (kPa) |
| E1 | −9 | 270 | 54 |
| E2 | −13 | 271 | 30 |
| E3 | −14 | 314 | 26 |
| E4 | −14 | 296 | 31 |
| E5 | −14 | 274 | 32 |
| E6 | −10 | 146 | 37 |
| E7 | −9 | 268 | 47 |
| E8 | −19 | 167 | 26 |
| E9 | −11 | 637 | 45 |
| E10 | −7 | 410 | 51 |
| E11 | −6 | 252 | 44 |
| E12 | 0 | 195 | 53 |
| E13 | −6 | 1036 | 75 |
| E14 | −16 | 444 | 37 |
| E15 | −1 | 150 | 30 |
| E16 | 0 | 240 | 32 |
| E17 | −19 | 138 | 18 |
| E18 | +11 | 183 | 28 |
| E19 | −6 | 287 | 32 |
| E20 | −8 | 389 | 31 |
| E21 | −11 | 444 | 32 |
| E22 | −1 | 161 | 16 |
| E23 | −7 | 257 | 29 |
| E24 | −10 | 235 | 64 |
| E25 | −10 | 330 | 65 |
| E26 | −13 | 187 | 51 |
| E27 | −11 | 211 | 57 |
| E28 | −13 | 224 | 46 |
| E29 | −10 | 151 | 45 |
| CE1 | −20 | 57 | 10 |
| CE2 | −15 | 65 | 20 |
| CE3 | −15 | 174 | 33 |
| CE4 | −15 | 291 | 79 |
| CE5 | −9 | 215 | 23 |
| CE6 | +5 | 345 | 41 |
| CE7 | −4 | 344 | 25 |
| CE8 | +1 | 144 | 24 |
| CE9 | +1 | 137 | 30 |
| CE10 | 0 | 152 | 42 |
| CE11 | −12 | 73 | 21 |
| CE12 | −4 | 329 | 49 |
| CE13 | −6 | 279 | 32 |
| CE14 | −11 | 437 | 26 |
| CE15 | −16 | 58 | 21 |
| CE16 | −19 | 101 | 42 |

TABLE 13
180 Degree Peel Adhesion, Dynamic Shear,
and Random Free-Fall Data of Transfer Tapes

| | | SS | Random |
|---|---|---|---|
| | SS Peel | Dynamic | Free Fall |
| | Adhesion | Shear | (drops to |
| Example | (N/mm) | (MPa) | failure) |
| E1 | 0.73 | 0.65 | 250+ |
| E2 | 0.95 | 0.81 | 250+ |
| E3 | 0.92 | 0.81 | 250+ |
| E4 | 1.05 | 0.75 | 250+ |
| E5 | 0.82 | 0.61 | 250+ |
| E6 | 0.93 | 1.12 | 250+ |
| E7 | 0.86 | 1.01 | 250+ |
| E8 | 0.77 | 0.69 | 60 |
| E9 | 1.05 | 1.12 | 250+ |
| E10 | 0.94 | 1.30 | 250+ |
| E11 | 0.87 | 1.34 | 250+ |
| E12 | 0.81 | 0.99 | 250+ |
| E13 | 1.00 | 1.38 | 100 |
| E14 | 0.90 | 1.03 | 250+ |
| E15 | 1.04 | 1.06 | 120 |
| E16 | 1.06 | 1.06 | 55 |
| E17 | 0.99 | 0.56 | 250+ |
| E18 | 1.03 | 1.12 | 81 |
| E19 | 0.8 | 0.86 | 250+ |
| E20 | 0.9 | 0.79 | 146 |
| E21 | 0.7 | 0.83 | 150 |
| E22 | 0.9 | 0.48 | 86 |
| E23 | 0.7 | 0.94 | 250+ |
| E24 | 0.5 | 0.47 | 128 |
| E25 | 0.5 | 0.43 | 66 |
| E26 | 0.5 | 0.65 | 250+ |
| E27 | 0.6 | 0.67 | 250+ |
| E28 | 0.6 | 0.82 | 250+ |
| E29 | 0.7 | 0.73 | 250+ |
| CE1 | 2.1† | 0.12 | 250+ |
| CE2 | 1.10 | 0.71 | 250+ |
| CE3 | 1.00 | 0.24 | 250+ |
| CE4 | 0.91 | 0.24 | 250+ |
| CE5 | 1.02 | 0.16 | 250+ |
| CE6 | 1.36 | 0.72 | 2 |
| CE7 | 1.63 | 0.72 | 5 |
| CE8 | 1.94 | 0.64 | 1 |
| CE9 | 1.87 | NT | 10 |
| CE10 | 1.31 | NT | 3 |
| CE11 | 1.0 | 0.79 | 250+ |
| CE12 | 1.0 | 1.03 | 250+ |
| CE13 | 0.8 | 1.05 | 250+ |
| CE14 | 0.7 | 0.29 | 250+ |
| CE15 | 0.5† | 0.27 | 3 |
| CE16 | 1.0 | 0.61 | 54 |

†= #2 bond failure

TABLE 14
Summary of Test Results for Samples Without Ionic Liquids

| | Shear | | SS | |
|---|---|---|---|---|
| | Modulus | SS Peel | Dynamic | Random |
| | (25° C., 1 Hz) | adhesion | Shear | Free Fall |
| Sample | (G′ > 100 kPa) | (≥0.5 N/mm) | (>0.4 MPa) | (>50 drops) |
| E1 | Pass | Pass | Pass | Pass |
| E2 | Pass | Pass | Pass | Pass |
| E3 | Pass | Pass | Pass | Pass |
| E4 | Pass | Pass | Pass | Pass |
| E5 | Pass | Pass | Pass | Pass |
| E6 | Pass | Pass | Pass | Pass |
| E7 | Pass | Pass | Pass | Pass |
| E8 | Pass | Pass | Pass | Pass |
| E9 | Pass | Pass | Pass | Pass |
| E10 | Pass | Pass | Pass | Pass |
| E11 | Pass | Pass | Pass | Pass |
| E12 | Pass | Pass | Pass | Pass |
| E13 | Pass | Pass | Pass | Pass |
| E14 | Pass | Pass | Pass | Pass |
| E15 | Pass | Pass | Pass | Pass |
| E16 | Pass | Pass | Pass | Pass |
| E17 | Pass | Pass | Pass | Pass |
| E18 | Pass | Pass | Pass | Pass |
| CE1 | Fail | Pass | Fail | Pass |
| CE2 | Fail | Pass | Pass | Pass |
| CE3 | Pass | Pass | Fail | Pass |
| CE4 | Pass | Pass | Fail | Pass |
| CE5 | Pass | Pass | Fail | Pass |
| CE6 | Pass | Pass | Pass | Fail |
| CE7 | Pass | Pass | Pass | Fail |
| CE8 | Pass | Pass | Pass | Fail |
| CE9 | Pass | Pass | NT | Fail |
| CE10 | Pass | Pass | NT | Fail |

NT = not tested

TABLE 15
Electro-Debonding

| | | % Reduction | % Reduction | % Reduction |
|---|---|---|---|---|
| | Initial | after 50 V | after 50 V | after 50 V |
| Sample | (MPa) | for 60 s | for 180 s | for 300 s |
| E19 | 0.83 | — | 66% | — |
| E20 | 0.86 | 77% | — | — |
| E21 | 0.85 | 80% | — | — |
| E22 | 0.88 | — | — | 74% |
| E23 | 0.96 | — | 72% | — |
| E24 | 0.58 | — | 64% | — |
| E25 | 0.56 | — | 93% | — |
| E26 | 0.64 | — | 83% | — |
| E27 | 0.73 | — | 82% | — |
| E28 | 0.63 | — | 65% | — |
| E29 | 0.65 | — | 61% | — |
| CE11 | 0.33 | — | 79% | — |
| CE12 | 0.94 | — | 4% | — |
| CE13 | 0.85 | — | — | 26% |
| CE14 | 0.82 | — | 67% | — |
| CE15 | 0.62 | — | 3% | — |
| CE16 | 1.00 | — | 4% | — |

TABLE 16
Corrosion Test Results

| | PET to Cu Foil at | |
|---|---|---|
| | 65° C./90% RH. | |
| Sample | 1 day | 3 days |
| E19 | 1 | 2 |
| E20 | 1 | 2 |
| E21 | 1 | 2 |
| E22 | 1 | 1 |
| E23 | 1 | 1 |
| E24 | 1 | 1 |
| E25 | 1 | 1 |
| E26 | 1 | 1 |
| E27 | 1 | 1 |
| E28 | 1 | 2 |
| E29 | 1 | 1 |
| CE11 | 1 | 1 |
| CE12 | 1 | 1 |
| CE13 | 1 | 1 |
| CE14 | 2 | 3 |
| CE15 | 3 | 3 |
| CE16 | 3 | 3 |

TABLE 17
Summary of Test Results for Samples With Ionic Liquids

| | | | | | | Electro- |
|---|---|---|---|---|---|---|
| | | | | | Corrosion | debonding |
| | Shear Modulus | SS Peel | SS Dynamic | Random | Test | (>50% peak |
| | (25° C., 1 Hz) | adhesion | Shear | Free Fall | (<25% after | force |
| Sample | (G′ > 100 kPa) | (≥0.5 N/mm) | (>0.4 MPa) | (>50 drops) | 3 days) | reduction) |
| E19 | Pass | Pass | Pass | Pass | Pass | Pass |
| E20 | Pass | Pass | Pass | Pass | Pass | Pass |
| E21 | Pass | Pass | Pass | Pass | Pass | Pass |
| E22 | Pass | Pass | Pass | Pass | Pass | Pass |
| E23 | Pass | Pass | Pass | Pass | Pass | Pass |
| E24 | Pass | Pass | Pass | Pass | Pass | Pass |
| E25 | Pass | Pass | Pass | Pass | Pass | Pass |
| E26 | Pass | Pass | Pass | Pass | Pass | Pass |
| E27 | Pass | Pass | Pass | Pass | Pass | Pass |
| E28 | Pass | Pass | Pass | Pass | Pass | Pass |
| E29 | Pass | Pass | Pass | Pass | Pass | Pass |
| CE11 | Fail | Pass | Pass | Pass | Pass | Pass |
| CE12 | Pass | Pass | Pass | Pass | Pass | Fail |
| CE13 | Pass | Pass | Pass | Pass | Pass | Fail |
| CE14 | Pass | Pass | Fail | Pass | Fail | Pass |
| CE15 | Fail | Pass | Fail | Fail | Fail | Fail |
| CE16 | Pass | Pass | Pass | Pass | Fail | Fail |

Composite adhesives according to the present disclosure and those made with polymeric microspheres not derived from polar monomers were stretched in one direction by hand (i.e., uniaxial tensile deformation) and visually observed under an optical microscope. In the adhesives of the present disclosure comprising polymeric microspheres, wherein the polymeric microspheres are derived from polar monomer(s) (e.g., 5% methacrylic acid, MAA), the sample was transparent when stretched and the polymeric microspheres appeared to deform in the same direction of the stretching when viewed under the microscope. In composite adhesives, wherein the polymeric microspheres were made without polar monomers (e.g., 0% methacrylic acid, MAA), the samples appeared opaque when stretched and when the stretched sample was observed under the microscope, the polymeric microspheres showed little deformation and there appears to be pockets (presumably, of air) between the polymeric microspheres and the matrix. Based on the visual appearances of the samples, it is believed that the composite adhesives of the present disclosure have better interaction with the (meth)acrylate-based matrix, enabling the microspheres to deform with the matrix when stretched.

Although not wanting to be limited by theory, it is believed that composite adhesives of the present disclosure have improved toughness compared with adhesives comprising polymeric microspheres made without polar monomers. The improved toughness is due to the enhanced interaction between the polar monomers used to generate the polymeric microsphere and the matrix. When composites comprising polymeric microspheres derived from polar monomers are stretched in one direction the polymeric microsphere deform (e.g., become spheroidal) with the matrix and therefore can help bear the load of stress (i.e. enhance toughness). However, when polar monomers are not used in the making of the polymeric microspheres and the composite is stretched, the polymeric microspheres do not appear to grossly change shape and matrix detaches from the microsphere when the adhesive is stretched in one direction, and as such the microsphere does not add to the adhesive toughness (i.e. non load bearing).

Foreseeable modifications and alterations of this invention will be apparent to those skilled in the art without departing from the scope and spirit of this invention. This invention should not be restricted to the embodiments that are set forth in this application for illustrative purposes.

1. A polymerizable composition comprising:
(i) a polymerizable matrix comprising:
(a) a (meth)acrylate macromer, wherein the (meth)acrylate macromer comprises a poly(ethylene oxide) group, a poly(propylene oxide) group, a poly(ethylene oxide-co-propylene oxide), a poly(tetrahydrofuran) group, or combinations thereof;
(b) one or more of a C₁ to C₂₀ (meth)acrylate ester monomer; and
(c) a cross-linking agent; and
(ii) a plurality of polymeric microspheres, wherein the polymeric microspheres are derived from at least 20 to at most 99 wt % of a (meth)acrylate monomer having a Tg above room temperature and at least 1 wt % of a polar (meth)acrylate monomer.

2. (canceled)

3. (canceled)

4. (canceled)

5. (canceled)

6. The composition according to claim 1, wherein the plurality of polymeric microspheres has an average particle diameter of at least 10 micrometers and at most 200 micrometers.

7. The composition according to claim 1, wherein the plurality of polymeric microspheres are derived from 50 to 99 wt % of the (meth)acrylate monomer.

8. (canceled)

9. The composition according to claim 1, wherein the composition comprises at least 0.5 and at most 40 wt % of the plurality of polymeric microspheres based on the polymerizable matrix.

10. The composition according to claim 1, wherein the polymerizable matrix comprises up to 50 weight percent of the (meth)acrylate macromer.

11. The composition according to claim 1, wherein the (meth)acrylate macromer has a number average molecule weight no greater than 10,000 Daltons.

12. (canceled)

13. The composition according to claim 1, wherein the (meth)acrylate macromer comprises a poly(ethylene oxide) group.

14. The composition according to claim 1, wherein the C₁ to C₂₀ (meth)acrylate ester monomer comprises 2-methyl butyl acrylate, 2-ethyl hexyl acrylate, butyl acrylate, iso-octyl acrylate, or combinations thereof.

15. The composition according to claim 1, wherein the polymerizable matrix comprises at least 10 wt % to at most 99.5 wt % of the C₁ to C₂₀ (meth)acrylate ester monomer.

16. The composition according to claim 1, wherein the polymerizable matrix further comprises a polar monomer.

17. (canceled)

18. (canceled)

19. The composition according to claim 1, wherein the cross-linking agent comprises a triazine, a multifunctional (meth)acrylate, or combinations thereof.

20. (canceled)

21. (canceled)

22. (canceled)

23. (canceled)

24. The composition according to claim 1, further comprising at least 0.5 and at most 20 wt % of an ionic liquid.

25. The composition according to claim 24, further comprising at least 0.7 and less than 10 wt % of a non-polymerizable ionic liquid.

26. The composition according to claim 24, wherein the ionic liquid comprises least one of the following: a nitrogen-containing cation ion, a phosphonium ion, or a sulfonium ion cation.

27. The composition according to claim 24, wherein the ionic liquid comprises at least one of the following: a sulfate, a sulfonate, a carboxylate, a phosphate, a borate, an imide, sulfonylimide, imide, halide anion, or dicyanamide.

28. An at least partially polymerized reaction product of the polymerizable composition according to claim 1.

29. An adhesive article comprising an adhesive composition derived from the polymerizable composition according to claim 1, wherein the adhesive composition is disposed on a substrate.

30. (canceled)

31. (canceled)

32. (canceled)

33. The adhesive article according to claim 29, wherein the adhesive article is a tape, or a label.

34. (canceled)

35. (canceled)

36. (canceled)

37. (canceled)

38. A method of making an adhesive article comprising:
(i) obtaining a polymerizable matrix comprising:
(a) at least 1 wt % of a (meth)acrylate macromer, wherein the (meth)acrylate macromer comprises a poly(ethylene oxide) group, a poly(propylene oxide) group, a poly(ethylene oxide-co-propylene oxide), a poly(tetrahydrofuran) group, or combinations thereof,
(b) one or more of a C₁ to C₂₀ (meth)acrylate ester monomer; and
(c) a cross-linking agent; and
(ii) adding a plurality of polymeric microspheres to the polymerizable matrix to form a composition, wherein the polymeric microspheres are derived from 20 to 99 wt % of (meth)acrylate monomer having a Tg above room temperature and at least 1 wt % of a polar (meth)acrylate monomer.

39. A method of claim 38, comprising at least partially polymerizing the polymerizable matrix to form an at least partially polymerized composition, before adding the plurality of polymeric microspheres.

40. (canceled)

41. (canceled)

42. (canceled)
